(19) United States
(12) Patent Application Publication
(10) Pub. No.: US 2026/0057834 A1
(43) Pub. Date: Feb. 26, 2026

(54) DISPLAY PANEL AND DISPLAY DEVICE

(71) Applicant: Xiamen Tianma Display Technology Co., Ltd., Xiamen (CN)

(72) Inventors: Jian KUANG, Xiamen (CN); Xingyao ZHOU, Xiamen (CN); Yana GAO, Xiamen (CN)

(21) Appl. No.: 19/236,503

(22) Filed: Jun. 12, 2025

(30) Foreign Application Priority Data
Aug. 26, 2024 (CN) 202411177931.9

(51) Int. Cl. G09G 3/3233

(52) U.S. Cl. CPC G09G 3/3233; G09G 2300/0819; G09G 2300/0842; G09G 2300/0861; G09G 2310/0286; G09G 2310/08; G09G 2320/0247; G09G 2330/021; G09G 2340/0435

(57) ABSTRACT

A display panel includes a plurality of cascaded shift register units, where a shift register unit includes a driving unit, an output unit, a first control unit and a second control unit. The driving unit has a signal shifting function. The output unit is connected to an output of the driving unit, an output of the first control unit and an output of the second control unit respectively. A first output signal includes n valid pulses. In a first working mode of the shift register unit, the output unit is configured to receive at least the first output signal, a first control signal output by the first control unit and a second control signal output by the second control unit, and output a second output signal. The second output signal includes n valid pulses, where n is a positive integer not less than 2.

### CROSS-REFERENCE TO RELATED DISCLOSURE

The present disclosure claims priority of Chinese Patent Disclosure No. 202411177931.9, filed on Aug. 26, 2024, the entire content of which is hereby incorporated by reference.

### FIELD OF THE DISCLOSURE

The present disclosure relates to the field of display technology, and in particular to a display panel and a display device.

### BACKGROUND

In order to improve the consumer experience, the refresh frequency of display products is getting higher and higher. The higher the display frequency, the greater the power consumption, which affects the use time of electronic products. The multi-area multi-frequency display technology has become one of the options to solve the display power consumption problem. The multi-area multi-frequency display means that different areas on a screen can be displayed at different refresh rates, which can reduce power consumption. However, the current shift register unit cannot be used in the multi-area multi-frequency display technology to support the output of multiple pulses, which affects the display effect.

### SUMMARY

One aspect of the present disclosure provides a display panel, including N cascaded shift register units, where a shift register unit includes a driving unit, an output unit, a first control unit, and a second control unit, and N is a positive integer, and where an output of the driving unit outputs a first output signal, and a first output signal output by a driving unit of an i-th level shift register unit is an input signal of a driving unit of a j-th level shift register unit, where 1≤i≤N, 1≤j≤N, i and j are both positive integers, and i≠j; the output unit is connected to an output of the driving unit, an output of the first control unit, and an output of the second control unit respectively; and the first output signal includes n valid pulses, in a first working mode of the shift register unit, the output unit is configured to at least receive the first output signal, a first control signal output by the first control unit, and a second control signal output by the second control unit, and output a second output signal, where the second output signal includes n valid pulses, n is a positive integer, and n≥2.

Another aspect of the present disclosure provides a display device. The display device includes a display panel, and the display panel includes including N cascaded shift register units, where a shift register unit includes a driving unit, an output unit, a first control unit, and a second control unit, and N is a positive integer, and where an output of the driving unit outputs a first output signal, and a first output signal output by a driving unit of an i-th level shift register unit is an input signal of a driving unit of a j-th level shift register unit, where 1≤i≤N, 1≤j≤N, i and j are both positive integers, and i≠j; the output unit is connected to an output of the driving unit, an output of the first control unit, and an output of the second control unit respectively; and the first output signal includes n valid pulses, in a first working mode of the shift register unit, the output unit is configured to at least receive the first output signal, a first control signal output by the first control unit, and a second control signal output by the second control unit, and output a second output signal, where the second output signal includes n valid pulses, n is a positive integer, and n≥2.

Other aspects of the present disclosure can be understood by those skilled in the art in light of the description, the claims, and the drawings of the present disclosure.

### BRIEF DESCRIPTION OF THE DRAWINGS

In order to more thoroughly illustrate the technical solutions of the embodiments of the present disclosure, the drawings essential for understanding the embodiments will be briefly introduced hereinafter. Apparently, the drawings described below are merely some embodiments of the present disclosure. For a person skilled in the art, other drawings can be obtained based on these drawings without creative efforts.

FIG. 1 is a schematic diagram of a pixel circuit in accordance with an embodiment of the present disclosure;

FIG. 2 is a working timing diagram of the pixel circuit in FIG. 1;

FIG. 3 is a schematic diagram of a shift register unit in the related art;

FIG. 4 is a timing diagram of the operation of the gating unit in FIG. 3;

FIG. 5 is a schematic diagram of a display panel in accordance with an embodiment of the present disclosure;

FIG. 6 is a schematic diagram of a shift register in accordance with an embodiment of the present disclosure;

FIG. 7 is a timing diagram of a pixel circuit in accordance with an embodiment of the present disclosure;

FIG. 8 is a timing diagram of a display panel in accordance with an embodiment of the present disclosure;

FIG. 9 is a schematic diagram of another display panel in accordance with an embodiment of the present disclosure;

FIG. 10 is a schematic diagram of another shift register unit in accordance with an embodiment of the present disclosure;

FIG. 11 is a timing diagram of the shift register unit in the first working mode;

FIG. 12 is a timing diagram of the shift register unit in the second working mode;

FIG. 13 is a schematic diagram of a driving unit in accordance with an embodiment of the present disclosure;

FIG. 14 is a timing diagram of the driving unit in accordance with the illustrated embodiment in FIG. 13;

FIG. 15 is a schematic diagram of another shift register unit in accordance with an embodiment of the present disclosure;

FIG. 16 is a schematic diagram of another shift register unit in accordance with an embodiment of the present disclosure;

FIG. 17 is a schematic diagram of another shift register unit in accordance with an embodiment of the present disclosure;

FIG. 18 is another timing diagram in accordance with an embodiment of the present disclosure;

FIG. 19 is another timing diagram in accordance with an embodiment of the present disclosure;

FIG. 20 is a schematic diagram of a cascade of shift register units in accordance with an embodiment of the present disclosure;

FIG. 21 is a schematic diagram of a circuit in another display panel in accordance with an embodiment of the present disclosure;

FIG. 22 is another signal timing diagram in accordance with an embodiment of the present disclosure;

FIG. 23 is another signal timing diagram in accordance with an embodiment of the present disclosure;

FIG. 24 is a schematic diagram of another shift register in accordance with an embodiment of the present disclosure;

FIG. 25 is a working timing diagram of a first control unit in accordance with an embodiment of the present disclosure;

FIG. 26 is another timing diagram in accordance with an embodiment of the present disclosure;

FIG. 27 is another timing diagram in accordance with an embodiment of the present disclosure;

FIG. 28 is a schematic diagram of a circuit in another display panel in accordance with an embodiment of the present disclosure;

FIG. 29 are other signal timing diagrams in accordance with an embodiment of the present disclosure; and

FIG. 30 is a schematic diagram of a display device in accordance with an embodiment of the present disclosure.

### DETAILED DESCRIPTION

In order to better understand the technical solution of the present disclosure, the embodiments of the present disclosure are described in detail hereinafter with reference to the accompanying drawings.

It should be noted that the described embodiments are merely part of the embodiments of the present disclosure, rather than all the embodiments of the present disclosure. Based on the embodiments in the present disclosure, all some embodiments obtained by a person skilled in art without creative effort are within the scope of protection of the present disclosure.

The terms used in the embodiments of the present disclosure are merely for the purpose of describing specific embodiments, and are not intended to limit the present disclosure. The singular forms “a”, “said” and “the” used in the embodiments of the present disclosure and the appended claims are also intended to include plural forms, unless the context clearly indicates other meanings.

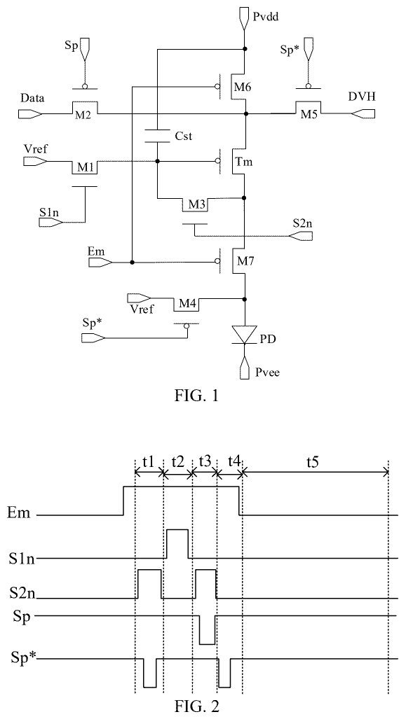

FIG. 1 illustrates a schematic diagram of a pixel circuit in accordance with an embodiment of the present disclosure, and FIG. 2 is a working timing diagram of the pixel circuit in FIG. 1. As shown in FIG. 1, the pixel circuit includes a driving transistor Tm, a gate reset transistor M1, a data writing transistor M2, a threshold compensation transistor M3, an electrode reset transistor M4, a bias transistor M5, a first light-emitting control transistor M6, a second light-emitting control transistor M7 and a storage capacitor Cst. The driving transistor Tm is connected in series between the first light-emitting control transistor M6 and the second light-emitting control transistor M7, and the first light-emitting control transistor M6 receives a first power supply voltage Pvdd. The second light-emitting control transistor M7 and the electrode reset transistor M4 are respectively connected to one electrode of the light-emitting element PD, and the other electrode of the light-emitting element PD receives a second power supply voltage Pvee. Here, the active layers of the threshold compensation transistor M3 and the gate reset transistor M1 include metal oxide, and both are N-type transistors, and the active layers of other transistors in the pixel circuit include silicon, and are P-type transistors. Such a configuration can reduce the leakage current from the threshold compensation transistor M3 and the gate reset transistor M1 to the gate of the driving transistor Tm, which improves the gate potential stability of the driving transistor Tm. Additionally, the bias transistor M5 is configured to write the bias signal DVH to one electrode of the driving transistor Tm to adjust the bias state of the driving transistor Tm, which improves the hysteresis effect of the driving transistor Tm. The bias signal DVH can be a constant voltage signal.

Refer to FIG. 2, the period t1 is the first bias stage, the period t2 is the gate reset stage, the period t3 is the data writing stage, the period t4 is the second bias stage, and the period t5 is the light emitting stage. During the period t1, the second scanning signal S2n provides an enable signal, the third scanning signal Sp* provides an enable signal, the threshold compensation transistor M3 and the bias transistor M5 are turned on to write the bias signal DVH to the gate of the driving transistor Tm and optimize the hysteresis effect of the driving transistor Tm, and the electrode reset transistor M4 is turned on to write a reset signal Vref to an electrode of the light-emitting device PD. During the period t2, the first scanning signal S1n provides an enable signal, the gate reset transistor M1 is turned on to write a reset signal Vref to the gate of the driving transistor Tm to reset the gate of the driving transistor Tm. In the t3 period, the second scanning signal S2n provides an enable signal, the fourth scanning signal Sp provides an enable signal, the threshold compensation transistor M3 and the data writing transistor M2 are turned on, and the data voltage Data is written to the gate of the driving transistor Tm. In the t4 period, the third scanning signal Sp* provides an enable signal again to control the bias transistor M5 to turn on and write a bias signal DVH to the first electrode of the driving transistor Tm to adjust the bias state of the driving transistor Tm. In the t5 period, the light-emitting control signal Em provides an enable signal, the first light-emitting control transistor M6 and the second light-emitting control transistor M7 are turned on, and the driving transistor Tm generates a driving current under the control of its gate, and provides the driving current to the light-emitting device PD to control the light-emitting device PD to emit light.

Since the display panel is driven row-by-row for display, the first scanning signal S1n, the second scanning signal S2n, the third scanning signal Sp*, the fourth scanning signal Sp, and the light-emitting control signal Em need to be provided by their respective shift registers. From the timing diagram of FIG. 2, in the working cycle of a pixel circuit, the second scanning signal S2n needs to provide two valid pulses, and the third scanning signal Sp* also needs to provide two valid pulses.

In the case of multi-area multi-frequency display, each scanning signal in a high-frequency refresh zone provides a signal as shown in the timing diagram of FIG. 2 to drive a pixel circuit to work, while a low-frequency refresh zone does not need to write data voltage in some display frames. That is, in some display frames, the second scanning signal S2n in the high-frequency refresh zone is required to be a signal with two valid pulses, while the second scanning signal S2n in the low-frequency refresh zone does not provide a valid pulse. When the timing diagram shown in FIG. 2 is used to drive a pixel circuit, in order to realize multi-area multi-frequency display, the shift register unit is required to have a gating function. If the input signal has two valid pulses, the output signal can be gated to output a signal including two valid pulses or a signal that does not include a valid pulse (i.e., a constant voltage signal).

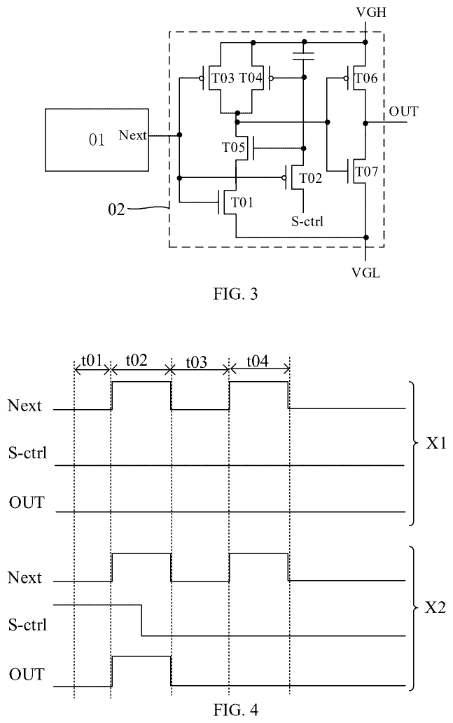

FIG. 3 is a schematic diagram of a shift register unit in the related art, and FIG. 4 is a timing diagram of the operation of the gating unit in FIG. 3. As shown in FIG. 3, the shift register unit includes a driving unit 01 and a gating unit 02, and the driving unit 01 has a signal shifting function and a conventional shift register structure. The gating unit 02 is connected to the output Next of the driving unit 01, and the gating unit 02 includes a first switch transistor T01 to a seventh switch transistor T07. The first switch transistor T01, the fifth switch transistor T05 and the seventh switch transistor T07 are N-type transistors, and the remaining switch transistors are P-type transistors. The control ends of the first switch transistor T01, the second switch transistor T02 and the third switch transistor T03 are respectively connected to the output Next of the driving unit 01, the sixth switch transistor T06 is connected to the high level signal VGH, and the seventh switch transistor T07 is connected to the low level signal VGL.

As shown in FIG. 4, the output Next of the driving unit 01 outputs two high level valid pulses.

Under the first gating state X1 of the gating unit 01: in the period t01, the output Next outputs a low level signal to control the second switch transistor T02 and the third switch transistor T03 to turn on, the second switch transistor T02 is turned on to write a low level of the control signal S-ctrl into the gate of the fourth switch transistor T04 and the gate of the fifth switch transistor T05, so that the fourth switch transistor T04 is turned on and the fifth switch transistor T05 is turned off. The third switch transistor T03 and the fourth switch transistor T04 are turned on to write the high level signal VGH into the gate of the sixth switch transistor T06 and the gate of the seventh switch transistor T07. The sixth switch transistor T06 is turned off, the seventh switch transistor T07 is turned on, and the output OUT of the shift register outputs a low level signal. In the t02 period, which is also the period when the output Next outputs the first valid pulse, the high level signal of the output Next controls the first switch transistor T01 to turn on, while the fifth switch transistor T05 maintains the “off” state of the previous period, and the fourth transistor T04 maintains the “on” state. The seventh switch transistor T07 is then turned on, the sixth switch transistor T06 is turned off, and the output OUT of the shift register still outputs a low level signal. In the subsequent t03 period and t04 period, the output OUT of the shift register maintains outputting the low level signal. In the first selection state X1, the output Next of the driving unit 01 outputs two valid pulses, and the output OUT of the selection unit 01 does not output a valid pulse.

Under the second gating state X2 of the gating unit 01: in the period t01, the output Next outputs a low level signal to control the second switch transistor T02 and the third switch transistor T03 to turn on, the second switch transistor T02 is turned on, and a high level of the control signal S-ctrl is written into the gates of the fourth switch transistor T04 and the fifth switch transistor T05, so that the fourth switch transistor T04 is turned off and the fifth switch transistor T05 is turned on. The third switch transistor T03 is turned on to write the high level signal VGH into the gates of the sixth switch transistor T06 and the seventh switch transistor T07, the seventh switch transistor T07 is turned on, and the output OUT of the shift register outputs a low level signal. In the period t02, the high level signal of the output Next controls the first switch transistor T01 to turn on. At the same time, the gate of the fifth switch transistor T05 maintains the high level of the previous period so that the fifth switch transistor T05 is turned on, and the low level signal VGL is written to the gate of the sixth switch transistor T06 and the gate of the seventh switch transistor T07. The sixth switch transistor T06 is turned on, the seventh switch transistor T07 is turned off, and the output OUT of the shift register outputs a high level signal. In the period t02, the control signal S-ctrl leaps from a high level to a low level. In the period t03, the output Next outputs a low level signal to control the second switch transistor T02 and the third switch transistor T03 to turn on. The second switch transistor T02 is turned on to write the low level of the control signal S-ctrl to the gate of the fourth switch transistor T04 and the gate of the fifth switch transistor T05, so that the fourth switch transistor T04 is turned on and the fifth switch transistor T05 is in an “off” state, thereby controlling the sixth switch transistor T06 to be turned off and the seventh switch transistor T07 to be turned on, and the output OUT of the shift register outputs a low level signal. In the period t04, which is also the period when the output Next outputs the second valid pulse, since the fifth switch transistor T05 maintains an “off” state, the low level signal cannot be written into the gate of the sixth switch transistor T06, resulting in the output OUT of the shift register maintaining outputting the low level signal. That is, when the output Next of the driving unit 01 outputs two valid pulses, the output OUT of the gating unit 01 can only output one valid pulse, and the loss of the valid pulse will cause flickering and image sticking problems, affecting the display effect. It can be seen that the shift register unit in the related art cannot meet the application of the multi-pulse of the second scanning signal S2n in the timing diagram of FIG. 2 in the multi-area with multi-frequency display.

In order to solve the problems existing in the related art, embodiments of the present disclosure provide a display panel, in which the structure of the gating unit in the shift register unit is configured such that the gating unit can support multi-pulse output to meet the application requirements of the multi-area multi-frequency display technology.

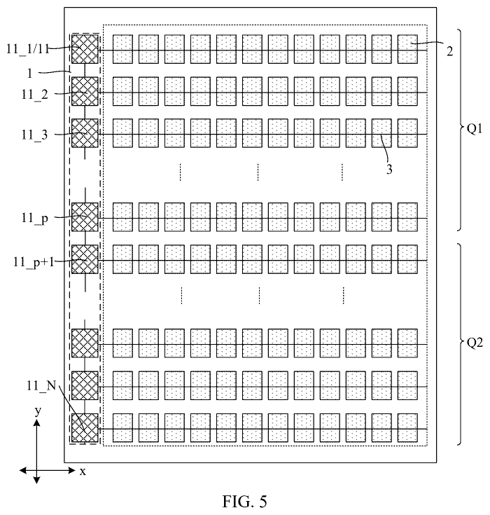

FIG. 5 is a schematic diagram of a display panel in accordance with an embodiment of the present disclosure. As shown in FIG. 5, the display panel includes a first shift register 1 and a plurality of pixel circuits 2. The display panel also includes light-emitting elements (not shown in FIG. 5), and the light-emitting elements are electrically connected to the pixel circuits 2. A light-emitting element may be an organic light-emitting element or an inorganic light-emitting element. The first shift register 1 includes N cascaded shift register units 11, where the N shift register units 11 are arranged along the column direction y. The output of a shift register unit 11 is connected to a plurality of pixel circuits 2 arranged in the row direction x. For example, the output of a shift register unit 11 is connected to a plurality of pixel circuits 2 through at least one scanning line 3 extending along the row direction x. N is a positive integer, and the column direction y intersects with the row direction x. FIG. 5 illustrates a 1st level shift register unit 11_1, a p-th level shift register unit 11_p, and an N level shift register unit _N, where p is an integer, and 1<p<N.

In FIG. 5, the first shift register 1 is arranged on one side of the pixel circuit array along the row direction x. Alternatively, the first shift register 1 may also be arranged on both sides of the pixel circuit array along the row direction x. Optionally, a pixel circuit 2 includes, but is not limited to, the circuit structure provided in FIG. 1. The threshold compensation transistor M3 in the pixel circuit 2 is connected to the output of a shift register unit 11. It can be seen that in order to drive the display panel to display, shift registers that provide the first scanning signal S1n, the third scanning signal Sp*, the fourth scanning signal Sp, and the light-emitting control signal Em, respectively, are also required.

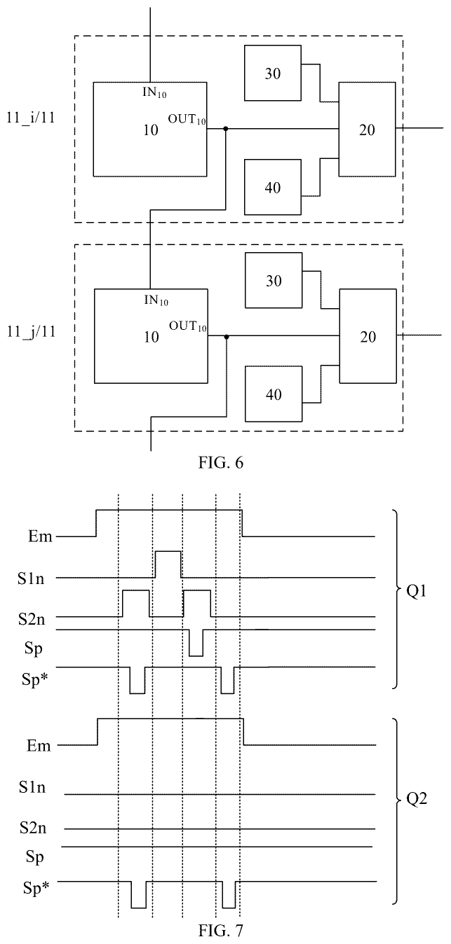

FIG. 6 is a schematic diagram of a shift register in accordance with an embodiment of the present disclosure, and FIG. 6 schematically illustrates an i-th level shift register unit 11_i and a j-th level shift register unit 11_j in the first shift register, where 1≤i≤N, 1≤j≤N, i and j are both positive integers, and i≠j. Optionally, i+1=j.

As shown in FIG. 6, a shift register unit 11 includes a driving unit 10, an output unit 20, a first control unit 30, and a second control unit 40. The output OUT10 of the driving unit 10 outputs a first output signal, and the first output signal output by the driving unit 10 of the i-th level shift register unit 11_i is the input signal of the driving unit 10 of the j-th level shift register unit 11_j. That is, the output OUT10 of the driving unit 10 of the i-th level shift register unit 11_i is connected to the input IN10 of the driving unit 10 of the j-th level shift register unit 11_j. In other words, the driving unit 10 has a signal shifting function. The driving unit 10 can be any structure in the existing technology that can realize the signal shifting function.

The output unit 20 is connected to the output OUT10 of the driving unit 10, the output of the first control unit 30 and the output of the second control unit 40 respectively. The first output signal output by the driving unit 10 includes n valid pulses, where a valid pulse refers to a pulse level that can control a transistor connected to the shift register unit 11 to turn on. The valid pulse of the first output signal can be a high level valid pulse or a low level valid pulse. For example, the high level valid pulse refers to a high level period in a signal as a valid pulse period, and the low level period is an invalid pulse period.

In the first working mode of the shift register unit 11, the output unit 20 is configured to receive at least a first output signal outputted by the output OUT10 of the driving unit 10, a first control signal outputted by the first control unit 30, and a second control signal outputted by the second control unit 40, and output a second output signal, where the second output signal includes n valid pulses, n is a positive integer, and n≥2. The second output signal has the same valid pulse type as the first output signal.

In the display panel in accordance with an embodiment of the present disclosure, the shift register unit 11 includes a driving unit 10, an output unit 20, a first control unit 30 and a second control unit 40, and the driving unit 10 has a signal shifting function. In the first working mode of the shift register unit 11, when the driving unit 10 outputs n valid pulses, the output unit 20 can output n valid pulses under the joint control of the driving unit 10, the first control unit 30 and the second control unit 40. When applying the multi-area multi-frequency display technology, the shift register unit 11 can meet the requirements of the pixel circuits in the high-frequency refresh area for multi-pulse signals, and avoid the problem of poor display effect caused by the lack of valid pulses.

Here, the shift register unit 11 can support the timing requirements of the second scanning signal S2n in the multi-area multi-frequency display as shown in the timing diagram of FIG. 2. The display panel disclosed in the embodiments of the present disclosure can thus apply the multi-area multi-frequency display technology for display. For example, the upper half of a screen is a video playback, and a high refresh rate of 120 Hz is used to display the picture, while the text in the lower part can be displayed at a refresh rate of 30 Hz, which can minimize the display function.

In some embodiments, the shift register unit 11 also includes a second working mode. In the second working mode of the shift register unit 11, the output unit 20 is configured to receive at least the first output signal output by the output OUT10 of the driving unit 10, the third control signal output by the first control unit 30 and the fourth control signal output by the second control unit 40, and output a constant voltage signal, where the third control signal and the fourth control signal are constant voltage signals. That is, in the second working mode of the shift register unit 11, the output unit 20 is controlled by the driving unit 10, the first control unit 30 and the second control unit 40 to output a constant voltage signal. The first control unit 30, the second control unit 40 and the output unit 20 serve as a gating unit in the shift register unit 11, and can selectively output n valid pulses or output a constant voltage signal when the driving unit 10 provides n valid pulses. The embodiments of the present disclosure can realize that among the N cascaded shift register units 11, some of the shift register units 11 are in the first working mode and output n valid pulses, and some of the shift register units 11 are in the second working mode and output a constant voltage signal. In this way, the requirement of a pixel circuit 2 for a multi-pulse signal when the multi-area multi-frequency display technology is applied can be met, thereby avoiding the problem of poor display effect caused by the missing valid pulses.

In some embodiments, in a first display frame of the display panel, the 1st level shift register unit 11_1 to the p-th level shift register unit 11_p are in the first operating mode, the (p+1)-th level shift register unit 11_p+1 to the q-th level shift register unit 11_q are in the second operating mode, where p and q are positive integers, and 1<p<q≤N.

Taking q=N as an example, as shown in FIG. 5, the 1st level shift register unit 11_1 to the p-th level shift register unit 11_p are connected to multiple pixel circuits 2 in the first display area Q1, and the (p+1)-th level shift register unit 11_p+1 to the N-th level shift register unit 11_N are connected to multiple pixel circuits 2 in the second display area Q2.

FIG. 7 is a timing diagram of a pixel circuit in accordance with an embodiment of the present disclosure. FIG. 7 illustrates the working timing of a pixel circuit 2 in the first display area Q1 and another pixel circuit 2 in the second display area Q2 in the display panel in a first display frame. The output of the shift register unit 11 is connected to the threshold compensation transistor M3 in a pixel circuit 2 as shown in FIG. 1. The operation of a pixel circuit 2 is described in conjunction with FIG. 1 and FIG. 2.

In the first display frame, the 1st level shift register unit 11_1 to the p-th level shift register unit 11_p is in the first working mode, and the signals output by the 1st level shift register unit 11_1 to the p-th level shift register unit 11_p respectively includes n valid pulses.

When n=2, the 1st level shift register unit 11_1 to the p-th level shift register unit 11_p can provide the second scanning signal S2n with two valid pulses required by the first display area Q1 as shown in FIG. 7, and cooperate with the operation of other shift registers so that the pixel circuits 2 in the first display area Q1 can execute the period t1 to the period t5 as shown in FIG. 2, so as to control the light-emitting element to emit light.

In the first display frame, the (p+1)-th level shift register unit 11_p+1 to the N-th level shift register unit 11_N (when q=N) are in the second working mode, and the signals output by the (p+1)-th level shift register unit 11_p+1 to the N-th level shift register unit 11_N are constant voltage signals, which can provide the second scanning signal S2n without a valid pulse as expected by the second display area Q2 shown in FIG. 7. Since the second scanning signal S2n does not provide an enable signal, the threshold compensation transistor M3 is turned off, and the gate of the driving transistor Tm in a pixel circuit 2 in the second display area Q2 does not perform data writing and the first biasing. The first shift register cooperates with other shift registers so that the gate of the driving transistor Tm in a pixel circuit 2 in the second display area Q2 maintains the potential of the previous frame, and no new data voltage is written.

In the first display frame, the first display area Q1 performs image refresh, while the second display area Q2 does not perform image refresh, and the first display area Q1 and the second display area Q2 have different refresh rates. The embodiments of the present disclosure can realize the multi-area multi-frequency display of the display panel. Refer to FIG. 5, the first display area Q1 is the upper display area of the display panel, and the second display area Q2 is the lower display area of the display panel, that is, the upper part of the display panel is a high-frequency refresh area, and the lower part is a low-frequency refresh area.

The display panel in accordance with an embodiment of the present disclosure also includes a second display frame. In the second display frame, the N shift register units 11 are all in the first working mode, and the signals output by the N shift register units 11 include n valid pulses respectively. In the second display frame, each shift register unit 11 normally outputs a pulse signal to drive pixel circuits 2 to work, and the second display frame is a data refresh frame of the display panel. Taking the display panel shown in FIG. 5 as an example, in the second display frame, the first display area Q1 and the second display area Q2 both perform image refresh. The cooperation of the first display frame and the second display frame can realize the multi-area multi-frequency display of the display panel and reduce the power consumption of the display panel.

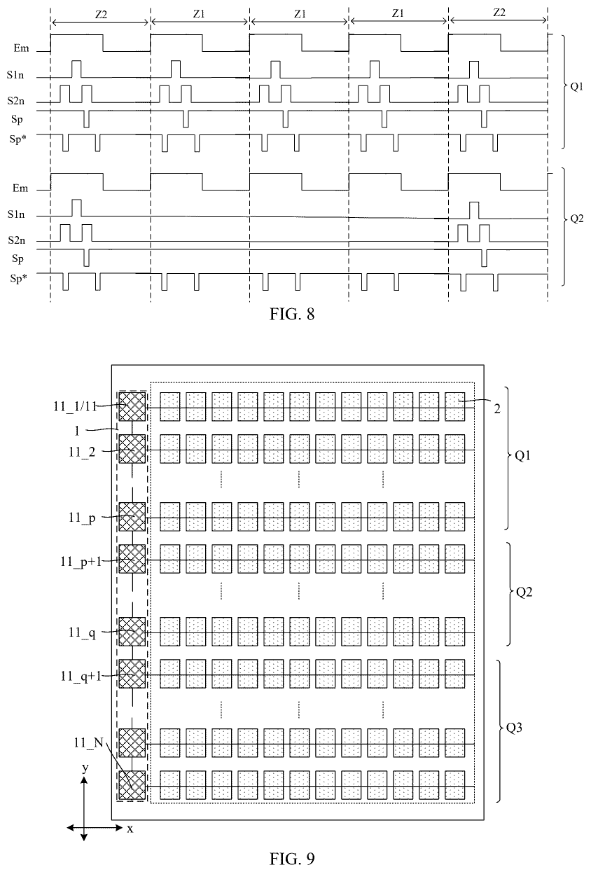

FIG. 8 is a timing diagram of a display panel in accordance with an embodiment of the present disclosure. FIG. 8 illustrates the signal timing required by pixel circuits 2 in the first display area Q1 and the second display area Q2. Combined with the pixel circuit timing diagram illustrated in FIG. 2, as shown in FIG. 8, the display panel includes first display frames Z1 and second display frames Z2, and three first display frames Z1 are executed between two adjacent second display frames Z2. In the second display frames Z2, the N shift register units 11 providing the second scanning signal S2n are all in the first working mode, and the first shift register 1 and other shift registers work in coordination so that the pixel circuits in the first display area Q1 and the pixel circuits in the second display area Q2 both execute the gate reset phase and the data writing phase, and the first display area Q1 and the second display area Q2 both refresh the image data. In the first display frame Z1, the 1st to p-th level shift register units 11 providing the second scanning signal S2n are in the first working mode, and the (p+1)-th to N-th level shift register units 11 are in the second working mode. The first shift register 1 and other shift registers work together so that only the pixel circuits in the first display area Q1 perform the gate reset phase and the data writing phase, while the second display area Q2 does not refresh the image data. The second display frames Z2 are the writing frames of the first display area Q1 and the second display area Q2. The first display frames Z1 are the writing frames of the first display area Q1 and the maintenance frames of the second display area Q2. In this way, the refresh rate of the first display area Q1 is greater than the refresh rate of the second display area Q2. For example, the first display area Q1 displays at a refresh rate of 120 Hz, and the second display area Q2 displays at a refresh rate of 30 Hz.

The embodiment of FIG. 8 illustrates a multi-area multi-frequency display scheme in which N cascaded shift register units 11 provide a second scanning signal S2n to cooperate in realizing a high-frequency display in the upper part and a low-frequency display in the lower part of the display panel. In some embodiments, in a writing frame, the N shift register units 11 providing the second scanning signal S2n are all in the first working mode; in a maintaining frame, the 1st to p-th level shift register units 11 providing the second scanning signal S2n are in the second working mode, and the (p+1)-th to N-th level shift register units 11 are in the first working mode. In this way, the upper part of the display panel can be displayed at a low frequency, and the lower part can be displayed at a high frequency.

In some embodiments, in the first display frame, the 1st level shift register unit 11_1 to the p-th level shift register unit 11_p are in the first working mode, the p+1-th level shift register unit 11_p+1 to the q-th level shift register unit 11_q are in the second working mode, the (q+1)-th level shift register unit 11_q+1 to the m-th level shift register unit 11_m are in the first working mode, where p, q, m are positive integers, and 1<p<q<m≤N. This embodiment can realize the multi-area multi-frequency display of at least three areas of the display panel.

Taking m=N as an example, a shift register unit 11 in the first shift register 1 is connected to the threshold compensation transistor M3 in a pixel circuit 2. FIG. 9 is a schematic diagram of another display panel in accordance with an embodiment of the present disclosure. As shown in FIG. 9, the display panel is divided into a first display area Q1, a second display area Q2 and a third display area Q3. The 1st level shift register unit 11_1 to the p-th level shift register unit 11_p are connected to the pixel circuits 2 in the first display area Q1, the (p+1)-th level shift register unit 11_p+1 to the q-th level shift register unit 11_q are connected to the pixel circuits 2 in the second display area Q2, and the (q+1)-th level shift register unit 11_q+1 to the m-th level shift register unit 11_m are connected to the pixel circuits 2 in the third display area Q3. When the display panel executes the first display frame, the first shift register 1 cooperates with other shift registers to make the first display area Q1 refresh the image data, the second display area Q2 does not refresh the image data, and the third display area Q3 refreshes the image data. When the display panel executes the second display frame, the first shift register 1 cooperates with other shift registers to make the first display area Q1, the second display area Q2 and the third display area Q3 all refresh the image data. At least one first display frame is executed between two adjacent second display frames, so that the three areas of the display panel perform high-frequency, low-frequency and high-frequency refresh display from top to bottom.

In some embodiments, the present disclosure may also implement a refresh display mode in which the first display area Q1, the second display area Q2 and the third display area Q3 are refreshed in low frequency, high frequency and low frequency from top to bottom.

In FIG. 9, the display area is only divided into three areas for displaying different frequencies. In some embodiments, the display area may be divided into four or more areas for displaying different frequencies according to display requirements.

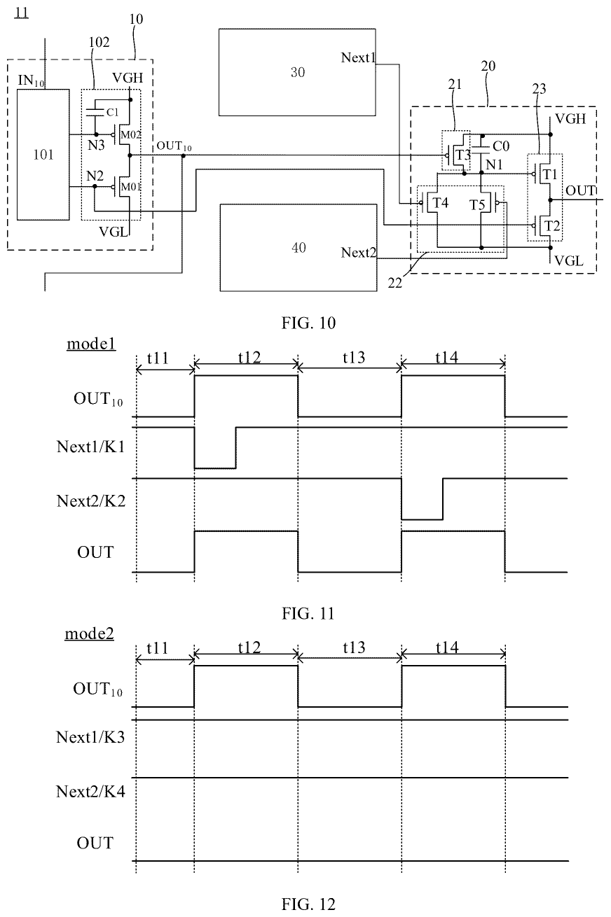

FIG. 10 is a schematic diagram of another shift register unit in accordance with an embodiment of the present disclosure. As shown in FIG. 10, the output unit 20 includes a first submodule 21, a second submodule 22, and an output submodule 23. The control end of the first submodule 21 is connected to the output OUT10 of the driving unit 10, and the two control ends of the second submodule 22 are respectively connected to the output Next1 of the first control unit 30 and the output Next2 of the second control unit 40. The output of the first submodule 21, the output of the second submodule 22, and at least one control end of the output submodule 23 are connected to the first node N1.

FIG. 11 is a timing diagram of the shift register unit in the first working mode. As shown in FIG. 11, in the first working mode 1, the output OUT10 of the driving unit 10 outputs a first output signal, which includes two valid pulses. The output Next1 of the first control unit 30 provides a first control signal K1 including a valid pulse, and the output Next2 of the second control unit 40 provides a second control signal K2 including a valid pulse.

It should be noted here, and the valid pulse types outputted by different unit structures may be different. If the valid pulse types of the first output signal and the second output signal are the same, the valid pulse of the second output signal is used to control the transistor connected to the shift register unit 11 to turn on. If the high level between two low levels in the first output signal is a valid pulse, then the valid pulse is a high level valid pulse. For the first control unit 30 and the second control unit 40, the control signals outputted by these two units are used to control the working state of the corresponding transistors in the output unit 20. Optionally, the first control unit 30 provides the first control signal K1 and the second control unit 40 provides the second control signal K2 of the same valid pulse type. If the low level between two high levels in the first control signal K1 is a valid pulse, then the valid pulse is a low level valid pulse.

The first submodule 21 is configured to be turned on during an invalid pulse period of a first output signal and turned off during an active pulse period of the first output signal provided by the output OUT10 of the driving unit 10.

The second submodule 22 is configured to be turned on during the valid pulse period of the first control signal K1 or the valid pulse period of the second control signal K2, and to be turned off during the period when both the first control signal K1 and the second control signal K2 are invalid pulses.

The output submodule 23 is configured to output the first level signal VGH when the signal corresponding to the first node N1 is in the second level period under the control of the first submodule 21 and the second submodule 22, and output the second level signal VGL when the signal corresponding to the first node N1 is in the first level period, and the first level signal VGH and the second level signal VGL form the second output signal. Taking the first level signal VGH as a high level signal as an example, the first level signal VGH and the aforementioned high level signal VGH use the same label. The second level signal VGL is a low level signal, and the second level signal VGL and the aforementioned low level signal VGL use the same label. Optionally, at the first node N1, the first level is a high level and the second level is a low level.

FIG. 11 takes the case where the valid pulse of the first output signal is a high level valid pulse and the valid pulses of the first control signal K1 and the second control signal K2 are low level valid pulses as an example. Then the low level period in the first output signal is an invalid pulse period, and the high level period in the first control signal K1 and the second control signal K2 is an invalid pulse period.

As shown in FIG. 11, in the first working mode 1, the working period includes a period t11, a period t12, a period t13 and a period t14. In the period t12, the first output signal provided by the output OUT10 of the driving unit 10 is the first valid pulse; in the period t14, the first output signal is the second valid pulse; and the periods t11 and t13 are invalid pulse periods of the first output signal.

During the period t11, the first output signal is an invalid pulse, and the first control signal K1 and the second control signal K2 are also invalid pulses. During this period, the first submodule 21 is turned on, the second submodule 22 is turned off, the first node N1 is controlled to correspond to the signal being at the first level (such as a high level), and the output submodule 23 outputs the second level signal VGL.

During the period t12, the first output signal is a valid pulse, and the first control signal K1 is a valid pulse. During this period, the first submodule 21 is turned off, the second submodule 22 is turned on, and the signal corresponding to the first node N1 is controlled to be at the second level (such as a low level), and the output submodule 23 outputs a first level signal VGH.

During the period t13, the first output signal is an invalid pulse, the first control signal K1 and the second control signal K2 are also invalid pulses; the first submodule 21 is turned on, the second submodule 22 is turned off, the first node N1 is controlled to be at the first level, and the output submodule 23 outputs a second level signal VGL.

During the period t14, the first output signal is a valid pulse and the second control signal K2 is a valid pulse. During this period, the first submodule 21 is turned off and the second submodule 22 is turned on to control the signal corresponding to the first node N1 to be at the second level, and the output submodule 23 outputs a first level signal VGH.

The disclosed embodiment sets the output unit 20 to include a first submodule 21, a second submodule 22 and an output submodule 23, and sets the connection relationship between the driving unit 10, the first control unit 30, the second control unit 40 and the submodules in the output unit 20. In the first working mode 1, the first output signal provided by the driving unit 10 controls the first submodule 21 to turn on to control the potential of the first node N1, and the first control signal K1 provided by the first control unit 30 and the second control signal K2 provided by the second control unit 40 alternately control the second submodule 22 to turn on to control the potential of the first node N1. In this way, the signal corresponding to the first node N1 can be alternately in the first level period and the second level period, so that the output submodule 23 can alternately output the first level signal VGH and the second level signal VGL to form a pulse signal. Here, the first control signal K1 provided by the first control unit 30 cooperates with the first output signal to make the output submodule 23 output the first valid pulse, and the second control signal K2 provided by the second control unit 40 cooperates with the first output signal to make the output submodule 23 output the second valid pulse, thereby allowing the shift register unit 11 to select and output the second output signal including two valid pulses.

FIG. 12 is a timing diagram of the shift register unit in the second working mode, according to some embodiments. As shown in FIG. 12, in the second working mode 2, the output OUT10 of the driving unit 10 outputs a first output signal, and the first output signal includes two valid pulses. The output Next1 of the first control unit 30 provides a third control signal K3, and the output Next2 of the second control unit 40 provides a fourth control signal K4. The third control signal K3 and the fourth control signal K4 are constant voltage signals and do not include valid pulses.

In the second working mode 2 of the shift register unit 11, the output unit 20 is configured to receive at least the first output signal, the third control signal K3 output by the first control unit 30 and the fourth control signal K4 output by the second control unit 40, and output a constant voltage signal. In the second working mode 2: the first submodule 21 is configured to be turned on during the invalid pulse period of the first output signal, and turned off during the valid pulse period of the first output signal. The second submodule 22 is configured to be turned off under the control of the third control signal K3 and the fourth control signal K4. The output submodule 23 is configured to output a constant voltage signal under the control of its control end. Optionally, the constant voltage signal output by the output submodule 23 is a second level signal VGL.

As shown in FIG. 12, the valid pulse of the first output signal is a high level valid pulse, and the third control signal K3 and the fourth control signal K4 are both high level, that is, in the invalid pulse period. That is, in the disclosed embodiment, the constant voltage signal of the third control signal K3 and the fourth control signal K4 is a first level signal VGH.

FIG. 12 illustrates the periods t11, t12, t13 and t14 in the second working mode 2. In the period t12, the first output signal provided by the output OUT10 of the driving unit 10 is the first valid pulse; in the period t14, the first output signal is the second valid pulse; and the periods t11 and t13 are invalid pulse periods of the first output signal.

During the period t11, the first output signal is an invalid pulse to control the first submodule 21 to turn on, the third control signal K3 and the fourth control signal K4 are both high level to control the second submodule 22 to turn off, the first submodule 21 is turned on to control the first node N1 to be at the first level, and the output submodule 23 outputs the second level signal VGL.

During the period t12, the first output signal is a valid pulse to control the first submodule 21 to turn off, the third control signal K3 and the fourth control signal K4 are both high levels to control the second submodule 22 to turn off, then the first node N1 maintains the first level, and the output submodule 23 continues to output the second level signal VGL.

Additionally, the working process of the period t13 is the same as that of the period t11, and the output submodule 23 outputs the second level signal VGL. The working process of the period t14 is the same as that of the period t12, and the output submodule 23 outputs the second level signal VGL.

In the second working mode 2, the third control signal K3 provided by the first control unit 30 and the fourth control signal K4 provided by the second control unit 40 cooperate with the first output signal, so that the output submodule 23 outputs a constant voltage signal, and the shift register unit 11 is enabled to output a constant voltage signal.

In some embodiments, as shown in FIG. 10, the input of the first submodule 21 and the first input of the output submodule 23 receive the first level signal VGH, and the input of the second submodule 22 and the second input of the output submodule 23 receive the second level signal VGL. In the first working mode 1: the first submodule 21 is configured to be turned on during the invalid pulse period of the first output signal and write the first level signal VGH to the first node N1. The second submodule 22 is configured to be turned on during the valid pulse period of the first control signal K1 or the valid pulse period of the second control signal K2 and write the second level signal VGL to the first node N1. The output submodule 23 is configured to output the second level signal VGL during the period when the first node N1 is the first level signal VGH, and output the first level signal VGH during the period when the first node N1 is the second level signal VGL. The disclosed embodiment uses the first submodule 21 and the second submodule 22 to control the potential of the first node N1 by alternately turning on, so that the first node N1 is alternately in the first level period and the second level period, so that the output submodule 23 can alternately output the first level signal VGH and the second level signal VGL to form a pulse signal, thereby allowing the shift register unit 11 to select and output the second output signal including two valid pulses in the first working mode 1.

In some embodiments, as shown in FIG. 10, the driving unit 10 includes an input module 101, a second node N2, a third node N3, and a driving output module 102. The input module 101 is connected to the input IN10 of the driving unit 10, and the input module 101 is used to control the potentials of the second node N2 and the third node N3. The two control ends of the driving output module 102 are respectively connected to the second node N2 and the third node N3, and the output of the driving output module 102 is connected to the output OUT10 of the driving unit 10. The driving output module 102 is configured to output a second level signal VGL under the control of the potential of the second node N2, and output a first level signal VGH under the control of the potential of the third node N3, and the first level signal VGH and the second level signal VGL form a first output signal.

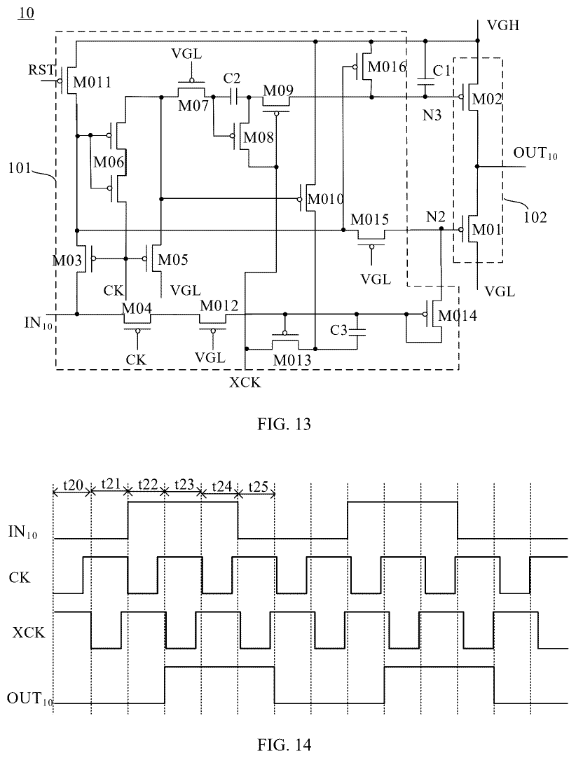

The following is a specific embodiment to illustrate the relationship between the potentials of the second node N2 and the third node N3 and the output signal of the driving output module 102. FIG. 13 is a schematic diagram of a driving unit in accordance with an embodiment of the present disclosure, and FIG. 14 is a timing diagram of the driving unit in accordance with the illustrated embodiment in FIG. 13.

As shown in FIG. 13, the driving unit 10 includes an input module 101 and a driving output module 102. The driving output module 102 includes a first output transistor M01 and a second output transistor M02, where the control end of the first output transistor M01 is connected to the second node N2, the first electrode is connected to the second level signal VGL, and the second electrode is connected to the output OUT10 of the driving unit 10. The control end of the second output transistor M02 is connected to the third node N3, the first electrode is connected to the first level signal VGH, and the second electrode is connected to the output OUT10 of the driving unit 10. The input module 101 is connected to the input IN10, the second node N2, and the third node N3 of the driving unit 10. The input module 101 includes an eighth switch transistor M03, a ninth switch transistor M04, a tenth switch transistor M05, an eleventh switch transistor M06, a twelfth switch transistor M07, a thirteenth switch transistor M08, a fourteenth switch transistor M09, a fifteenth switch transistor M010, a sixteenth switch transistor M011, a seventeenth switch transistor M012, an eighteenth switch transistor M013, a nineteenth switch transistor M014, a twentieth switch transistor M015, and a twenty-first switch transistor M016. The connection relationship of each switch transistor in the output module 101 is not repeated here. The driving unit 10 also includes a first capacitor C1, a second capacitor C2, and a third capacitor C3. Each switch transistor in the driving unit 10 is illustrated as a P-type transistor. In order to drive the driving unit 10, a first clock signal CK, a second clock signal XCK, and a constant voltage signal RST are also required. The constant voltage signal RST is a high level signal to control the sixteenth switch transistor M011 to be in an “off” state.

The working process of the driving unit 10 can be further described in conjunction with FIG. 14. After the input IN10 of the driving unit 10 inputs two pulse signals, the output OUT10 of the driving unit 10 outputs two pulse signals, and there is a time interval between the output signal and the input signal.

During the period t20: the first clock signal CK is at a low level to control the eighth switch transistor M03, the ninth switch transistor M04, and the tenth switch transistor M05 to be turned on, the eighth switch transistor M03 writes the low level of the input IN10 of the driving unit 10 to the second node N2, and the twenty-first switch transistor M016 is turned on to write the high level of the first level signal VGH to the third node N3. The first output transistor M01 is turned on, the second output transistor M02 is turned off, and the output OUT10 of the driving unit 10 outputs a low level.

During the period t21: the second clock signal XCK is at a low level to control the fourteenth switch transistor M09 to turn on and write the high level to the third node N3, and the second output transistor M02 remains in an “off” state. At the same time, the second node N2 maintains a low level, the first output transistor M01 is turned on, and the output OUT10 of the driving unit 10 continues to output a low level.

During the period t22: The first clock signal CK is at a low level, and the eighth switch transistor M03, the ninth switch transistor M04, and the tenth switch transistor M05 are turned on. The eighth switch transistor M03 writes the high level of the input IN10 of the driving unit 10 to the second node N2, and the first output transistor M01 is turned off. The second clock signal XCK is at a high level, the fourteenth switch transistor M09 is turned off, and the twenty-first switch transistor M016 is also turned off. The third node N3 then maintains a high level, and the second output transistor M02 is turned off. During this period, the output OUT10 of the driving unit 10 continues to output a low level.

During the period t23: the second node N1 maintains a high level to control the first output transistor M01 to be turned off; the thirteenth switch transistor M08 is turned on, and the second clock signal XCK is at a low level to control the fourteenth switch transistor M09 to be turned on. The low voltage is then written to the third node N3, the third node N3 is at a low level to control the second output transistor M02 to be turned on, and the output OUT10 of the driving unit 10 outputs a high level.

During the period t24, the second node N2 maintains a high level, the third node N3 is a low level, and the output OUT10 of the driving unit 10 outputs a high level.

During the period t25, although the input IN10 of the driving unit 10 is at a low level, since the first clock signal CK is at a high level, the low level cannot be written to the second node N2, and the second node N2 maintains a high level. The third node N3 is at a low level, and the output OUT10 of the driving unit 10 outputs a high level.

It should be noted in a period from t22 to t25, the second node N2 is at a high level; in a period from t20 to t22, the third node N3 is at a high level. In some periods, the second node N2 and the output OUT10 of the driving unit 10 have the same phase (both are positive potentials or both are negative potentials), and the moment when the second node N2 starts to be at a high level is earlier than the moment when the output OUT10 of the driving unit 10 starts to output a high level. The moment when the second node N2 ends at a low level is earlier than the moment when the output OUT10 of the driving unit 10 ends outputting a low level. For the third node N3, when the third node N3 is at a low level, the output OUT10 of the driving unit 10 outputs a high level.

As shown in FIG. 10, the output unit 20 includes a first submodule 21, a second submodule 22 and an output submodule 23. The control end of the first submodule 21 is connected to the output OUT10 of the driving unit 10, the two control ends of the second submodule 22 are respectively connected to the output Next1 of the first control unit 30 and the output Next2 of the second control unit 40, and the output of the first submodule 21 and the output of the second submodule 22 are connected to the first node N1. Here, the first control end of the output submodule 23 is connected to the first node N1, and the second control end is connected to the second node N2.

The output submodule 23 includes a first transistor T1 and a second transistor T2. The gate of the first transistor T1 is the first control end of the output submodule 23, and the gate of the second transistor T2 is the second control end of the output submodule 23. The gate of the first transistor T1 is connected to the first node N1, the first electrode receives the first level signal VGH, and the second electrode is connected to the output OUT of the output submodule 23. The gate of the second transistor T2 is connected to the second node N2, the first electrode receives the second level signal VGL, and the second electrode is connected to the output OUT of the output submodule 23. In FIG. 10, the first transistor T1 and the second transistor T2 are both P-type transistors for illustrative purposes. In some embodiments, the first transistor T1 and the second transistor T2 are both N-type transistors, which are not illustrated in the drawings.

The first submodule 21 includes a third transistor T3. The gate of the third transistor T3 is connected to the output OUT10 of the driving unit 10, the first electrode receives the first level signal VGH, and the second electrode is connected to the first node N1. The second submodule 22 includes a fourth transistor T4 and a fifth transistor T5. The gate of the fourth transistor T4 is connected to the output Next1 of the first control unit 30, the first electrode receives the second level signal VGL, and the second electrode is connected to the first node N1. The gate of the fifth transistor T4 is connected to the output Next2 of the second control unit 40, the first electrode receives the second level signal VGL, and the second electrode is connected to the first node N1. The output unit 20 also includes a fourth capacitor C0. One plate of the fourth capacitor C0 is connected to the first level signal VGH, and the other plate is connected to the first node N1.

In the disclosed embodiment, the potential of the first node N1 is controlled by the first submodule 21, the second submodule 22 and the output OUT10 of the driving unit 10, which then controls the first transistor T1. The second transistor T2 is controlled by the second node N2. The operation of the shift register unit 11 is understood by referring to the relationship between the potential of the second node N2 and the potential of the output OUT10 of the driving unit 10 in the illustrated embodiment in FIG. 13.

In the first working mode 1 as shown in FIG. 11:

During the period t12, the first output signal provided by the output OUT10 of the driving unit 10 is the first high level valid pulse, controlling the first submodule 21 to be turned off. The first control signal K1 provides a low level valid pulse to control the second submodule 22 to be turned on, and the low level of the second level signal VGL is written to the first node N1. The first node N1 is at a low level to control the first transistor T1 to be turned on. During this period, the second node N2 is at a high level, the second transistor T2 is turned off, and the output OUT of the output unit outputs a high level valid pulse.

During the period t13, the output OUT10 of the driving unit 10 provides an invalid pulse signal to control the first submodule 21 to turn on, and writes a high level to the first node N1 to control the first transistor T1 to turn off. During this period, the second node N2 is at a low level to control the second transistor T2 to turn on, and the output OUT10 of the output unit outputs a low level invalid pulse.

During the period t14, the first output signal provided by the output OUT10 of the driving unit 10 is the second high level valid pulse, controlling the first submodule 21 to be turned off. The second control signal K2 provides a low level valid pulse to control the second submodule 22 to be turned on, and the low level of the second level signal VGL is written to the first node N1. The first node N1 controls the first transistor T1 to be turned on, and the output OUT10 of the output unit outputs a high level valid pulse.

After the period t14, the low level of the second node N2 controls the second transistor T2 to turn on, and the output OUT of the output unit outputs a low level invalid pulse.

In the first working mode 1, the first output signal provided by the driving unit 10 controls the first submodule 21 to turn on to control the potential of the first node N1, the first control signal K1 provided by the first control unit 30 and the second control signal K2 provided by the second control unit 40 alternately control the second submodule 22 to turn on to control the potential of the first node N1, so that the first node N1 is alternately in a low level period and a high level period. In conjunction with the second node N2 controlling the output submodule 23, the output submodule 23 can alternately output the first level signal VGH and the second level signal VGL to form a pulse signal, thereby allowing the shift register unit 11 to select and output the second output signal including two valid pulses.

In the second working mode 2 as shown in FIG. 12:

During the period t11, the low level invalid pulse of the first output signal controls the first submodule 21 to turn on, the third control signal K3 and the fourth control signal K4 are both high level to control the second submodule 22 to turn off, and the first submodule 21 is turned on to control the first node N1 to write a high level, thereby controlling the first transistor T1 to turn off. During this period, the second node N2 is low level to control the second transistor T2 to turn on, so that the output submodule 23 outputs the second level signal VGL.

During the period t12, the first output signal is a high level valid pulse to control the first submodule 21 to turn off, and the third control signal K3 and the fourth control signal K4 still control the second submodule 22 to turn off, so the first node N1 maintains a high level. During this period, the second node N2 is controlled at a high level, and the second transistor T2 is turned off. The output submodule 23 maintains outputting the second level signal VGL.

The working process of the period t13 is the same as that of the period t11, and the working process of the period t14 is the same as that of the period t12. In the periods t13 and t14, the output submodule 23 outputs the second level signal VGL.

In the second working mode 2, the third control signal K3 provided by the first control unit 30 and the fourth control signal K4 provided by the second control unit 40 cooperate with the first output signal to control the first transistor T1 to be turned off and the second transistor T2 to be turned on intermittently so that the output submodule 23 maintains the output low level signal, thereby allowing the shift register unit 11 to select and output a constant voltage signal.

In the illustrated embodiment in FIG. 10, when the second node N2 is at a low level, the output OUT10 of the driving unit 10 is controlled to output the low level of the second level signal VGL. It should be noted that due to the existence of the threshold voltage of the transistor, the voltage of the low level signal output by the output OUT10 of the driving unit 10 is higher than the voltage of the second level signal VGL. Considering that if the gate of the second transistor T2 is connected to the output OUT10 of the driving unit 10, the output of the low level signal by the output OUT10 of the driving unit 10 may not be able to control the second transistor T2 to be fully turned on, which will affect the potential value of the low level signal output by the output submodule 23, thereby affecting the display effect. In the disclosed embodiment, the gate of the second transistor T2 is connected to the second node N2, and the low level of the second node N2 is lower than the potential of the low level signal output by the output OUT10 of the driving unit 10, which can ensure the “on” state of the second transistor T2, thereby ensuring that the potential value of the low level signal output by the output submodule 23 meets the requirements.

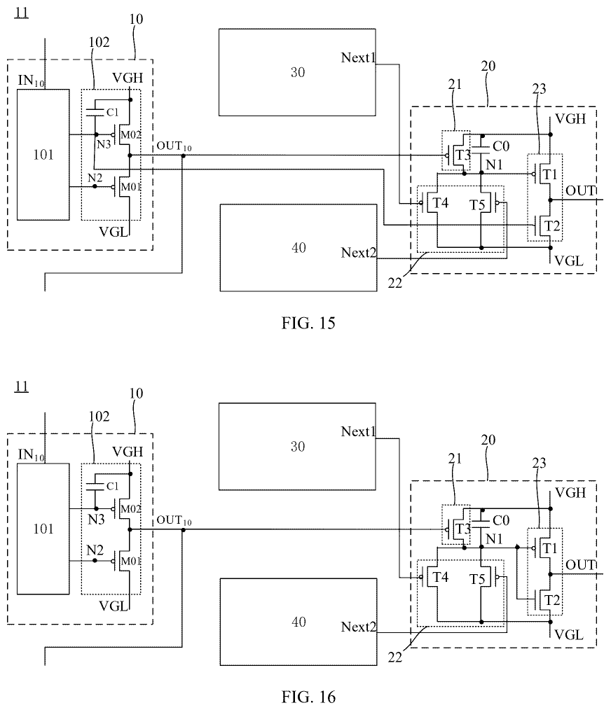

FIG. 15 is a schematic diagram of another shift register unit in accordance with an embodiment of the present disclosure. As shown in FIG. 15, the output unit 20 includes a first submodule 21, a second submodule 22, and an output submodule 23. The control end of the first submodule 21 is connected to the output OUT10 of the driving unit 10, and the two control ends of the second submodule 22 are respectively connected to the output Next1 of the first control unit 30 and the output Next2 of the second control unit 40. The output of the first submodule 21 and the output of the second submodule 22 are connected to the first node N1. The first control end of the output submodule 23 is connected to the first node N1, and the second control end is connected to the third node N3. The gate of the first transistor T1 in the output submodule 23 is connected to the first node, the first electrode receives the first level signal VGH, and the second electrode is connected to the output OUT of the output submodule 23. The gate of the second transistor T2 in the output submodule 23 is connected to the third node N3, the first electrode receives the second level signal VGL, and the second electrode is connected to the output OUT of the output submodule 23. FIG. 15 shows that the first transistor T1 is a P-type transistor and the second transistor T2 is an N-type transistor. In some embodiments, the first transistor T1 is an N-type transistor and the second transistor T2 is a P-type transistor.

When the driving unit 10 enters a working state, when the third node N3 is at a low level, the output OUT10 of the driving unit 10 outputs a high level, and when the third node N3 is at a high level, the output OUT10 of the driving unit 10 outputs a low level. When the first working mode 1 of the shift register unit 11 adopts the signal timing illustrated in FIG. 11, the output submodule 23 outputs a second output signal including two valid pulses. When the second working mode 2 of the shift register unit 11 adopts the signal timing illustrated in FIG. 12, the output submodule 23 outputs a second output signal including two valid pulses.

FIG. 16 is a schematic diagram of another shift register unit in accordance with an embodiment of the present disclosure. As shown in FIG. 16, the output unit 20 includes a first submodule 21, a second submodule 22 and an output submodule 23. The control end of the first submodule 21 is connected to the output OUT10 of the driving unit 10, the two control ends of the second submodule 22 are respectively connected to the output Next1 of the first control unit 30 and the output Next2 of the second control unit 40, and the output of the first submodule 21 and the output of the second submodule 22 are connected to the first node N1. The first control end and the second control end of the output submodule 23 are both connected to the first node N1. The gate of the first transistor T1 in the output submodule 23 is connected to the first node N1, the first electrode receives the first level signal VGH, and the second electrode is connected to the output OUT of the output submodule 23. The gate of the second transistor T2 is connected to the first node N1, the first electrode receives the second level signal VGL, and the second electrode is connected to the output OUT of the output submodule 23. FIG. 15 shows that the first transistor T1 is a P-type transistor and the second transistor T2 is an N-type transistor. In some embodiments, the first transistor T1 is an N-type transistor and the second transistor T2 is a P-type transistor.

In the disclosed embodiment, both control ends of the output submodule 23 are connected to the first node N1, and the first node N1 controls the two transistors. In the first working mode 1, the first output signal provided by the driving unit 10, the first control signal K1 provided by the first control unit 30, and the second control signal K2 provided by the second control unit 40 control the potential of the first node N1, so that the first node N1 is alternately in the low level period and the high level period, thereby controlling the first transistor T1 and the second transistor T2 to be alternately turned on, so that the shift register unit 11 is gated to output the second output signal including two valid pulses. In the second working mode 2, the third control signal K3 provided by the first control unit 30 and the fourth control signal K4 provided by the second control unit 40 control the second submodule 22 to be turned off, and the first output signal controls the first submodule 21 to be turned on to control the potential of the first node N1, so that the first transistor T1 is turned off and the second transistor T2 is turned on, so that the shift register unit 11 is gated to output the constant voltage signal.

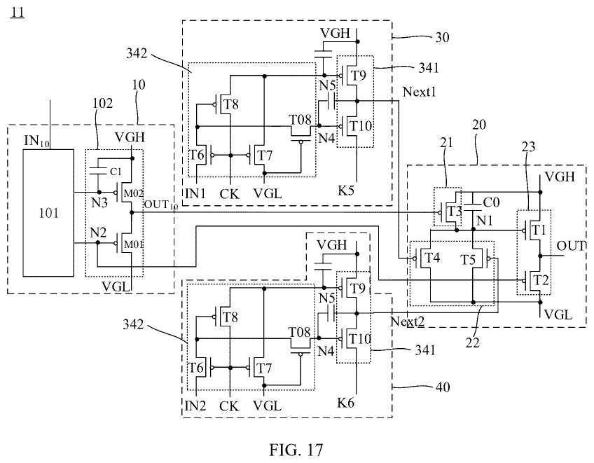

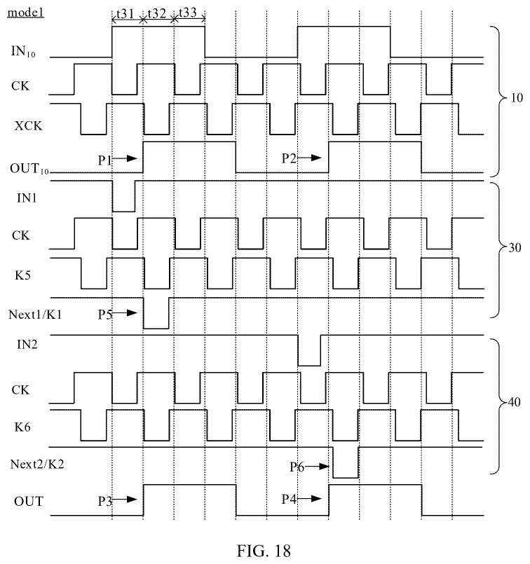

FIG. 17 is a schematic diagram of another shift register unit in accordance with an embodiment of the present disclosure, and FIG. 18 is another timing diagram in accordance with an embodiment of the present disclosure. FIG. 18 illustrates a signal timing that enables the shift register unit 11 to select and output the second output signal, that is, the shift register unit is in the first operating mode 1.

As shown in FIG. 17, the first control unit 30 and the second control unit 40 both include an output subunit 341 and an input subunit 342, and the control end of the output subunit 341 is connected to the input subunit 342. One input of the output subunit 341 in the first control unit 30 receives the first level signal VGH, and the other input receives the fifth control signal K5. One input of the output subunit in the second control unit 40 receives the first level signal VGH, and the other input receives the sixth control signal K6.

FIG. 18 illustrates the signal timing of the driving unit 10, the first control unit 30, the second control unit 40, and the output OUT of the output unit 20. Refer to FIG. 18, the output OUT10 of the driving unit 10 provides a first output signal, and the n valid pulses of the first output signal include a first valid pulse P1 and a second valid pulse P2. The output OUT of the output unit 20 outputs a second output signal, and the n valid pulses of the second output signal include a third valid pulse P3 and a fourth valid pulse P4. In the first working mode 1, the first control signal K1 provided by the output Next1 of the first control unit 30 includes the fifth valid pulse P5, and the second control signal K2 provided by the output Next2 of the second control unit 40 includes the sixth valid pulse P6. The output unit 20 is configured to output the third valid pulse P3 when at least the first valid pulse P1 and the fifth valid pulse P5 are received, and to output the fourth valid pulse P4 when at least the second valid pulse P2 and the sixth valid pulse P6 are received. The valid pulses of the first output signal and the second output signal are high level valid pulses, and the valid pulses of the first control signal K1 and the second control signal K2 are low level valid pulses.

In the first working mode 1 of the shift register unit 11 in the disclosed embodiment, a valid pulse provided by the output OUT10 of the driving unit 10 and a valid pulse provided by the output Next1 of the first control unit 30 cooperate to make the output OUT10 of the output unit 20 output a valid pulse. A valid pulse provided by the output OUT10 of the driving unit 10 and a valid pulse provided by the output Next2 of the second control unit 40 cooperate to make the output OUT10 of the output unit 20 output another valid pulse, thereby allowing the shift register unit 11 to select and output a signal including two valid pulses.

FIG. 18 takes n=2 as an example. In the embodiments of the present disclosure, n can also be an integer greater than 2, such as n=3 or 4.

Taking n=3 as an example, in the first working mode: the output OUT10 of the driving unit 10 in the shift register unit 11 provides a first output signal, the first output signal includes 3 valid pulses. The first control signal K1 provided by the output Next1 of the first control unit 30 includes 2 valid pulses, and the second control signal K2 provided by the output Next2 of the second control unit 40 includes 1 valid pulse. The first control unit 30 and the second control unit 40 alternately provide valid pulses to the output unit 20, and make the valid pulses cooperate with the first output signal to provide periods of valid pulses, so that the output of the output unit 20 can output a signal including 3 valid pulses.

Taking n=4 as an example, in the first working mode: the output OUT10 of the driving unit 10 in the shift register unit 11 provides a first output signal, where the first output signal includes 4 valid pulses. The first control signal K1 provided by the output Next1 of the first control unit 30 includes 2 valid pulses, and the second control signal K2 provided by the output Next2 of the second control unit 40 includes 2 valid pulses. The first control unit 30 and the second control unit 40 alternately provide valid pulses to the output unit 20, and make the valid pulses cooperate with the first output signal to provide periods of valid pulses, so that the output of the output unit 20 can output a signal including 4 valid pulses.

As shown in FIG. 18, in the first working mode 1, the fifth valid pulse P5 period and the first valid pulse P1 period at least partially overlap, and the sixth valid pulse P6 period and the second valid pulse P2 period at least partially overlap. Here, the start time of the fifth valid pulse P5 is not earlier than the start time of the first valid pulse P1, and the start time of the sixth valid pulse P6 is not earlier than the start time of the second valid pulse P2. In conjunction with the description of the illustrated embodiment in FIG. 10, the first valid pulse P1 and the second valid pulse P2 are used to control the first submodule 21 to be turned off, so that the first submodule 21 cannot write the high level provided by the first level signal VGH to the first node N1. The fifth valid pulse P5 and the sixth valid pulse P6 are used to control the second submodule 22 to be turned on and write the low level provided by the second level signal VGL to the first node N1, thereby controlling the output submodule 23 to output the high level provided by the first level signal VGH. At the ending time of the first valid pulse P1 and the ending time of the second valid pulse P2, the first node N1 starts to leap from a low level to a high level, which can control the first transistor T1 to be turned off. The start time of the fifth valid pulse P5 is set not earlier than the start time of the first valid pulse P1, and the start time of the sixth valid pulse P6 is set not earlier than the start time of the second valid pulse P2, so that the turning-on period of the second submodule 22 and the turning-on period of the first submodule 21 do not overlap, and the potential control of the first node N1 is more accurate, so that the stability of the output signal of the output submodule 23 is better.

As shown in FIG. 18, in the first working mode 1, the start time of the third valid pulse P3 is not earlier than the start time of the fifth valid pulse P5, the ending time of the third valid pulse P3 is not later than the ending time of the first valid pulse P1, the start time of the fourth valid pulse P4 is not earlier than the start time of the sixth valid pulse P6, and the ending time of the fourth valid pulse P4 is not later than the ending time of the second valid pulse P2. In conjunction with the description of the illustrated embodiment in FIG. 10, the fifth valid pulse P5 controls the second submodule 22 to turn on and write the low level to the first node N1, and the output submodule 23 can output a high level signal. That is, the start time of the third valid pulse P3 is affected by the start time of the fifth valid pulse P5, and the ending time of the third valid pulse P3 is affected by the ending time of the first valid pulse P1. Similarly, the start time of the fourth valid pulse P4 is affected by the start time of the sixth valid pulse P6, and the ending time of the fourth valid pulse P4 is affected by the ending time of the second valid pulse P2. By limiting the relationship between the start time and the ending time of each of the above-mentioned valid pulses, the pulse width of the third valid pulse P3 and the pulse width of the fourth valid pulse P4 can be adjusted according to actual needs.

Refer to FIG. 17 and FIG. 18, in the first working mode 1: the output subunit 341 of the first control unit 30 is configured to output the fifth valid pulse P5 according to the first level signal VGH and the fifth control signal K5, and the output subunit 341 of the second control unit 40 is configured to output the sixth valid pulse P6 according to the first level signal VGH and the sixth control signal K6. In the first working mode 1, the fifth control signal K5 and the sixth control signal K6 are periodic pulse signals, where the output subunit 341 in the first control unit 30 is configured to output the low level signal of the fifth control signal K5 and the high level of the first level signal VGH to form the fifth valid pulse P5, and the output subunit 341 in the second control unit 40 is configured to output the low level signal of the sixth control signal K6 and the high level of the first level signal VGH to form the sixth valid pulse P6. When the output unit 20 receives the first output signal, the first control signal K1 output by the first control unit 30 and the second control signal K2 output by the second control unit 40, the output OUT of the output unit 20 outputs the third valid pulse P3 and the fourth valid pulse P4, so that the shift register unit 11 selects and outputs a signal including two valid pulses.

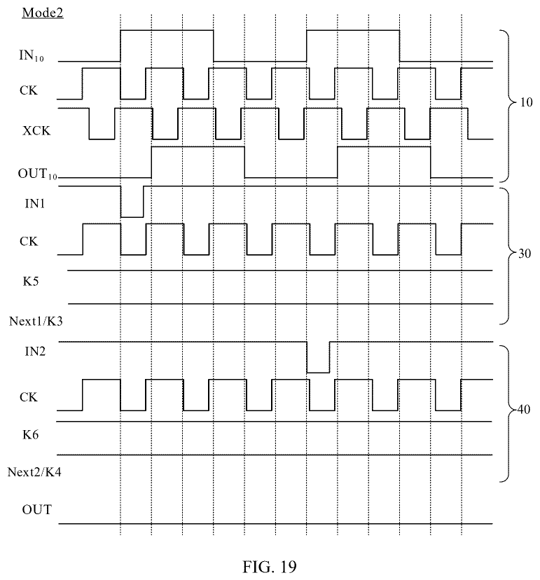

FIG. 19 is another timing diagram in accordance with an embodiment of the present disclosure. FIG. 19 illustrates a signal timing that can realize the shift register unit 11 to select and output a low level constant voltage signal, that is, the shift register unit is in the second working mode. FIG. 19 illustrates the signal timing of the driving unit 10, the first control unit 30, the second control unit 40, and the output OUT of the output unit 20. In conjunction with the embodiments illustrated in FIG. 17 and FIG. 19, in the second working mode 2: the fifth control signal K5 received by the first control unit 30 and the sixth control signal K6 received by the second control unit 40 are both first level signals VGH. The output subunit 341 of the first control unit 30 is configured to output the first level signal VGH as the third control signal K3.

The output subunit 341 of the second control unit 40 is configured to output the first level signal VGH as the fourth control signal K4. Furthermore, when the output unit 20 receives the first output signal, the third control signal K3 output by the first control unit 30 and the fourth control signal K4 output by the second control unit 40, the output OUT of the output unit 20 outputs a low level constant voltage signal, so that the shift register unit 11 is selected to output the constant voltage signal.

As shown in FIG. 17, the control end of the output subunit 341 in the first control unit 30 and the second control unit 40 is connected to the input subunit 342. The input subunit includes a sixth transistor T6, a seventh transistor T7 and an eighth transistor T8, and the output subunit includes a ninth transistor T9 and a tenth transistor T10.

The gate of the sixth transistor T6 and the gate of the seventh transistor T7 receive the first clock signal CK, the first electrode of the sixth transistor T6 in the first control unit 30 is connected to the input IN1 of the first control unit 30, the first electrode of the sixth transistor T6 in the second control unit 40 is connected to the input IN2 of the second control unit 40, and the second electrode of the sixth transistor T6 is connected to the fourth node N4. The first electrode of the seventh transistor T7 receives the second level signal VGL, and the second electrode is connected to the fifth node N5. The gate of the eighth transistor T8 is connected to the fourth node N4, the first electrode receives the first clock signal CK, and the second electrode is connected to the fifth node N5.

The gate of the ninth transistor T9 is connected to the fifth node N5, and the first electrode receives the first level signal VGH. In the first control unit 30, the second electrode of the ninth transistor T9 is connected to the output Next1 of the first control unit 30, and in the second control unit 40, the second electrode of the ninth transistor T9 is connected to the output Next2 of the second control unit 40. The gate of the tenth transistor T10 is connected to the fourth node. In the first control unit 30, the first electrode of the tenth transistor T10 receives the fifth control signal, and the second electrode is connected to the output Next1 of the first control unit 30. In the second control unit 40, the first electrode of the tenth transistor T10 receives the sixth control signal, and the second electrode is connected to the output Next2 of the second control unit 40.

FIG. 17 illustrates that the first control unit 30 and the second control unit 40 also include a normally-on transistor T08 and two voltage-stabilizing capacitors (not shown). The first control unit 30 and the second control unit 40 have the same structure, and the working process is described by taking the first control unit 30 as an example.

As shown in FIG. 18, in the first working mode 1 of the shift register unit 11: in the period t31, the low level of the first clock signal CK controls the sixth transistor T6 and the seventh transistor T7 to turn on, and after the sixth transistor T6 is turned on, the low level of the input IN1 of the first control unit 30 is written to the fourth node N4, and after the seventh transistor T7 is turned on, the low level of the second level signal VGL is written to the fifth node N5. At this time, the output Next1 of the first control unit 30 outputs a high level. In the period t32, the first clock signal CK is a high level, the fifth control signal K5 is a low level, the eighth transistor T8 maintains the “on” state to write the high level of the first clock signal CK to the fifth node N5, then the ninth transistor T9 is turned off, the fourth node N4 maintains a low level to control the tenth transistor T10 to turn on, and the output Next1 of the first control unit 30 outputs a low level. In the period t33, the output Next1 of the first control unit 30 outputs a high level. In this way, the output Next1 of the first control unit 30 outputs the fifth valid pulse P5. As can be seen from FIG. 18, there is a time interval between the output Next1 of the first control unit 30 outputting the fifth valid pulse P5 and the low level pulse inputted by the input IN1 of the first control unit 30. The first control unit 30 is a shift register unit having a signal function. In the shift register unit 11, the first control unit 30 and the second control unit 40 respectively have a signal shifting function.

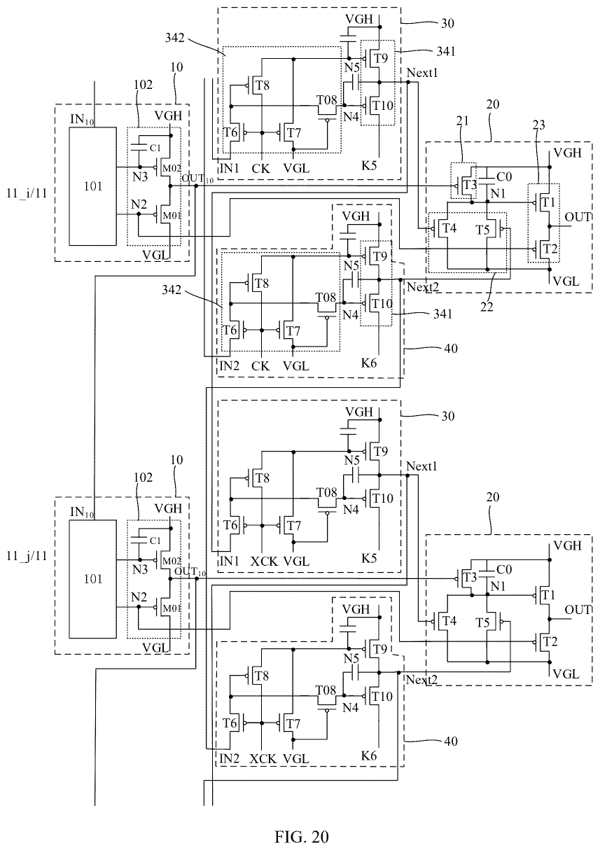

FIG. 20 is a schematic diagram of a cascade of shift register units in accordance with an embodiment of the present disclosure. FIG. 20 schematically illustrates an i-th level shift register unit 11_i and a j-th level shift register unit 11_j in the first shift register. As shown in FIG. 20, the output OUT10 of the driving unit 10 of the i-th level shift register unit 11_i is connected to the input IN10 of the driving unit 10 of the j-th level shift register unit 11_j. The output signal of the first control unit 30 in the i-th level shift register unit 11 is the input signal of the first control unit 30 in the j-th level shift register unit 11. The output signal of the second control unit 40 in the i-th level shift register unit 11 is the input signal of the second control unit 40 in the j-th level shift register unit 11. Taking i+1=j as an example, the output Next1 of the first control unit 30 in the i-th level shift register unit 11 is connected to the input IN1 of the first control unit 30 in the j-th level shift register unit 11, and the output Next2 of the second control unit 40 in the i-th level shift register unit 11 is connected to the input IN2 of the second control unit 40 in the j-th level shift register unit 11. In two adjacent shift register units, two driving units 10 are cascaded, two first control units 30 are cascaded, and two second control units 40 are cascaded.

As shown in FIG. 20, the first control unit 30 and the second control unit 40 in the i-th level shift register unit 11_i are connected to the first clock signal CK, and the first control unit 30 and the second control unit 40 in the j-th level shift register unit 11_j are connected to the second clock signal XCK. The first clock signal CK and the second clock signal XCK are a pair of clock signals, both of which are periodic pulse signals. When describing the structure of the first control unit 30 and the second control unit 40 in the shift register unit 11, it is understood that the first electrode of the eighth transistor T8 receives the first clock signal CK, or it can be said that the first electrode of the eighth transistor T8 receives the second clock signal XCK. When the shift register is working, the first clock signal CK and the second clock signal XCK have a certain time difference only in the high level and low level timing.

Additionally, the first clock signal CK and the second clock signal XCK may adopt the timing as shown in FIG. 14. That is, the first control unit 30 and the second control unit 40 may share the clock signal with the driving unit 10.

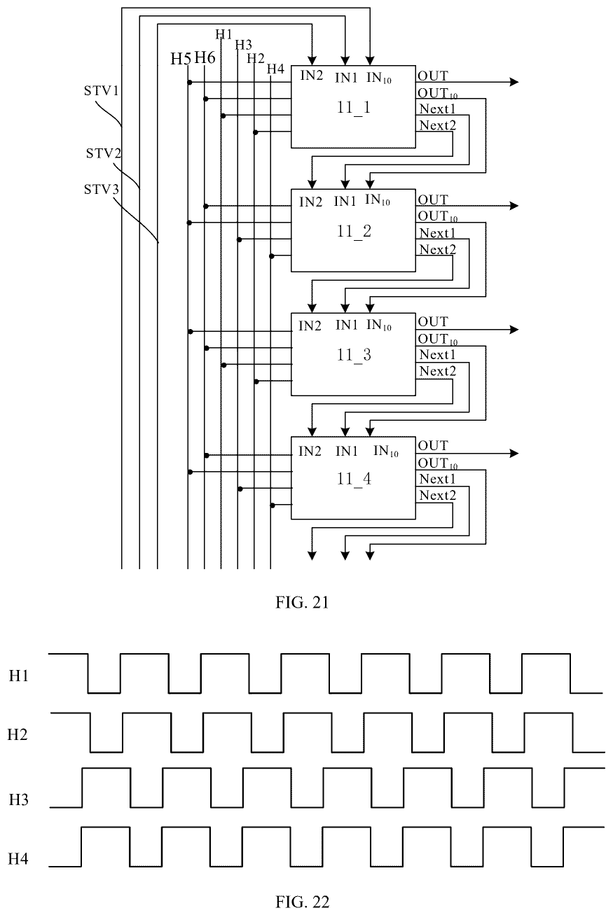

FIG. 21 is a schematic diagram of another circuit in a display panel in accordance with an embodiment of the present disclosure. As shown in FIG. 21, the display panel includes a first signal line H1, a second signal line H2, a third signal line H3, and a fourth signal line H4. The first signal line H1 and the third signal line H3 provide a fifth control signal K5, and the second signal line H2 and the fourth signal line H4 provide a sixth control signal K6. In the first working mode 1, the fifth control signal K5 and the sixth control signal K6 are periodic pulse signals. In the second working mode 2, the fifth control signal K5 and the sixth control signal K6 are constant voltage signals.

FIG. 21 illustrates the 1st level shift register unit 11_1 to the fourth level shift register unit 11_4 in the first shift register. In conjunction with the cascade relationship in the illustrated embodiment in FIG. 20, the output subunit 341 of the first control unit 30 in the 1st level shift register unit 11_1 and the third level shift register unit 11_3 is connected to the first signal line H1, and the output subunit 341 of the second control unit 40 is connected to the second signal line H2; the output subunit 341 of the first control unit 30 in the second level shift register unit 11_2 and the fourth level shift register unit 11_4 is connected to the third signal line H3, and the output subunit 341 of the second control unit 40 is connected to the fourth signal line H4. Additionally, the output Next1 of the output subunit 341 of the first control unit 30 is connected to the input IN1 of the first control unit 30 in the next level shift register unit 11, and the output Next2 of the output subunit 341 of the second control unit 40 is connected to the input IN2 of the second control unit 40 in the next level shift register unit 11.

That is, in the k-th level shift register unit 11: the output subunit of the first control unit 30 is connected to the first signal line H1, and the output subunit of the second control unit 40 is connected to the second signal line H2. k is a positive integer, and k<N. In the (k+1)-th level shift register unit 11: the output subunit of the first control unit 30 is connected to the third signal line H3, and the output subunit of the second control unit 40 is connected to the fourth signal line H4.

FIG. 22 is another signal timing diagram in accordance with an embodiment of the present disclosure. FIG. 22 illustrates the timing of signals provided by the first signal line H1 to the fourth signal line H4 when the k-th and (k+1)-th level shift register units are both in the first working mode. As shown in FIG. 22, when the k-th and (k+1)-th level shift register units are both in the first working mode, the first signal line H1 provides the fifth control signal K5 to the k-th level shift register unit, and the second signal line H2 provides the sixth control signal K6 to the k-th level shift register unit, and the fifth control signal K5 and the sixth control signal K6 driving the k-th level shift register unit to work are the same signal. The third signal line H3 provides the fifth control signal K5 to the (k+1)-th level shift register unit, and the fourth signal line H4 provides the sixth control signal K6 to the (k+1)-th level shift register unit, and the fifth control signal K5 and the sixth control signal K6 driving the (k+1)-th level shift register unit to work are the same signal. The signals provided by the first signal line H1 and the third signal line H3 in some periods are inverted signals. When the shift register unit is driven to the first working mode, the signals provided by the first signal line H1 and the third signal line H3 are similar to a pair of clock signals.

As shown in FIG. 21, the first start signal line STV1, the second start signal line STV2, and the third start signal line STV3 are also schematically shown. The input IN10 of the driving unit 10 in the 1st level shift register unit 11_1 is connected to the first start signal line STV1, the input IN10 of the first control unit 30 is connected to the second start signal line STV2, and the input IN 20 of the second control unit 40 is connected to the third start signal line STV3.

FIG. 21 also illustrates a first clock signal line H5 and a second clock signal line H6. The first clock signal line H5 and the second clock signal line H6 provide the first clock signal CK and the second clock signal XCK required by the driving unit 10 in the illustrated embodiment in FIG. 13, as well as the first clock signal CK required by the first control unit 30 and the second control unit 40 in the i-th level shift register unit 11_i and the second clock signal XCK required by the first control unit 30 and the second control unit 40 in the j-th level shift register unit 11_j in the illustrated embodiment in FIG. 20. Setting the first control unit 30, the second control unit 40, and the driving unit 10 to share the clock signal line can reduce the number of clock signal lines, which is beneficial to saving wiring space in the display panel.

In some of the above embodiments, the display panel includes a first display frame. In the first display frame, the 1st to p-th level shift register units 11 are in the first working mode, and the (p+1)-th to q-th level shift register units 11 are in the second working mode, where p and q are positive integers, and 1<p<q≤N. In the first working mode of the shift register unit 11, the output unit 20 is configured to at least receive the first output signal, the first control signal K1 output by the first control unit 30, and the second control signal K2 output by the second control unit 40, and output the second output signal including at least two valid pulses. In the second working mode of the shift register unit 11, the output unit 20 is configured to at least receive the first output signal, the third control signal K3 output by the first control unit 30, and the fourth control signal K4 output by the second control unit 40, and output a constant voltage signal. From the illustrated embodiment in FIG. 17, whether the output Next1 of the first control unit 30 outputs the first control signal K1 or the third control signal K3 is affected by the fifth control signal K5, and whether the output Next2 of the second control unit 40 outputs the second control signal K2 or the fourth control signal K4 is affected by the sixth control signal K6. That is, in the odd-numbered shift register unit, the output signal of the first control unit 30 is controlled by the first signal line H1, and the output signal of the second control unit 40 is controlled by the second signal line H2; in the even-numbered shift register unit, the output signal of the first control unit 30 is controlled by the third signal line H3, and the output signal of the second control unit 40 is controlled by the fourth signal line H4.

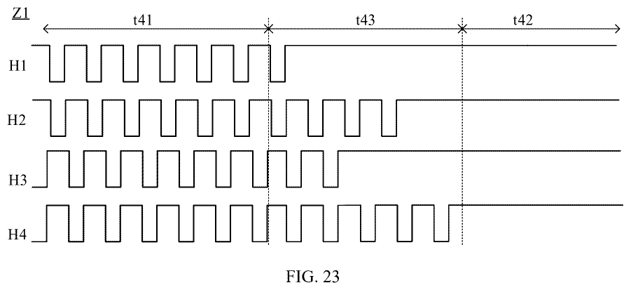

FIG. 23 is another signal timing diagram in accordance with an embodiment of the present disclosure. FIG. 23 illustrates the signal timing on the first signal line H1 to the fourth signal line H4 when driving the display panel to display the first display frame. As shown in FIG. 23, the first display frame Z1 includes a first period t41 and a second period t42.

In the first period t41, the first signal line H1, the second signal line H2, the third signal line H3, and the fourth signal line H4 provide periodic pulse signals respectively. The first signal line H1 and the second signal line H2 provide the same signal, and the third signal line H3 and the fourth signal line H4 provide the same signal. In the second period t42, the first signal line H1 and the second signal line H2 provide constant voltage signals respectively, and the third signal line H3 and the fourth signal line H4 provide constant voltage signals respectively, such as high level constant voltage signals.

Adopting the signal timing illustrated in FIG. 23, the shift register unit 11 driven by the four signal lines can be in the first working mode in the first period t41, and the shift register unit 11 driven by the four signal lines can be in the second working mode in the second period t42, so that different display areas of the display panel in the first display frame Z1 can be refreshed differently. For example, the 1st to p-th level shift register units 11 are in the first working mode, and the corresponding display areas refresh the image data, while the (p+1)-th to q-th level shift register units 11 are in the second working mode, and the corresponding display areas do not refresh the image data. In the second period t42, the four signal lines provide constant voltage signals respectively, which can help reduce power consumption.

In some embodiments, in the second period t42, the first signal line H1 and the second signal line H2 provide constant voltage signals respectively, and the third signal line H3 and the fourth signal line H4 provide periodic pulse signals respectively; or, in the second period t42, the first signal line H1 and the second signal line H2 provide periodic pulse signals respectively, and the third signal line H3 and the fourth signal line H4 provide constant voltage signals respectively, which are not illustrated here. That is, in the first display frame Z1, only the signals provided by some signal lines are changed into constant voltage signals, which can also play a role in reducing power consumption.

Additionally, it can be understood that in the second display frame, the first signal line H1, the second signal line H2, the third signal line H3, and the fourth signal line H4 respectively provide periodic pulse signals, so that each shift register unit 11 is in the first working mode.

As shown in FIG. 23, the first display frame Z1 includes a third period t43, and the third period t43 is located between the first period t41 and the second period t42. In the third period t43, the signals provided by the first signal line H1 and the second signal line H2 are respectively changed from periodic pulse signals to constant voltage signals, and the time when the signal on the first signal line H1 leaps is earlier than the time when the signal on the second signal line H2 leaps; and/or, the signals provided by the third signal line H3 and the fourth signal line H4 are respectively changed from periodic pulse signals to constant voltage signals; and the time when the signal on the third signal line H3 leaps is earlier than the time when the signal on the fourth signal line H4 leaps. In conjunction with the illustrated embodiments in FIG. 20 and FIG. 21, the first signal line H1 is connected to the first control unit 30 in the odd-numbered shift register unit 11, and the second signal line H2 is connected to the second control unit 40 in the odd-numbered shift register unit 11. Since the shift register units are cascaded, the time when the signal on the first signal line H1 in the first display frame Z1 leaps is set earlier than the time when the signal on the second signal line H2 leaps, so as to ensure that the shift register unit 11 connecting the first signal line H1 and the second signal line H2 normally outputs n valid pulses in the first working mode, thereby avoiding the loss of pulse signals, and ensuring the display effect. Similarly, in the first display frame Z1, the time when the signal on the third signal line H3 leaps is set earlier than the time when the signal on the fourth signal line H4 leaps, so as to ensure that the shift register unit 11 connecting the third signal line H3 and the fourth signal line H4 normally outputs n valid pulses in the first working mode, so as to avoid the loss of pulse signals. The embodiments of the present disclosure can ensure that display abnormality will not occur near the boundary of the multi-area multi-frequency display in the first display frame Z1.

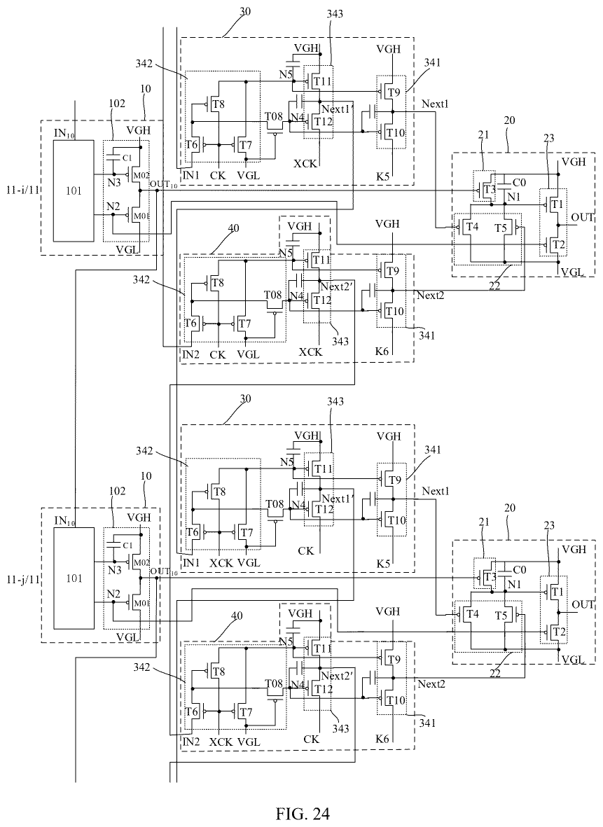

FIG. 24 is another schematic diagram of a shift register in accordance with an embodiment of the present disclosure. FIG. 24 illustrates two cascaded shift register units. As shown in FIG. 24, the first control unit 30 and the second control unit 40 both include an output subunit 341, an input subunit 342, and a stage transmission subunit 343, and the control end of the output subunit 341 and the control end of the stage transmission subunit 343 are respectively connected to the input subunit 342. One input of the stage transmission subunit 343 receives a first level signal VGH, and the other input receives a second clock signal XCK.

The output Next1′ of the stage transmission subunit 343 of the first control unit 30 in the i-th level shift register unit 11_i is connected to the input IN1 of the input subunit 342 of the first control unit 30 in the j-th level shift register unit 11_j, and the output Next1 of the output subunit 342 in the first control unit 30 is connected to one control end of the second subunit 22 in the output unit 20. The output Next2′ of the stage transmission subunit 343 of the second control unit 40 in the i-th level shift register unit 11 is connected to the input IN2 of the input subunit 342 of the second control unit 40 in the j-th level shift register unit 11_j. The output Next1 of the output subunit 342 in the second control unit 40 is connected to the other control end of the second subunit 22 in the output unit 20.

The stage transmission subunit 343 in the first control unit 30 is configured to realize the cascade connection of two first control units 30 in two adjacent shift register units 11, and the output subunit 341 in the first control unit 30 is configured to provide a control signal to the output unit 20. The output signal of the output subunit 341 in the first control unit 30 may be the same as or different from the output signal of the stage transmission subunit 343. For example, in the first working mode of the shift register unit 11, the stage transmission subunit 343 in the first control unit 30 outputs a valid pulse, and the output subunit 341 also outputs a valid pulse; in the second working mode, the stage transmission subunit 343 in the first control unit 30 outputs a valid pulse, and the output subunit 341 outputs a constant voltage signal

The stage transmission subunit 343 in the second control unit 40 is configured to realize the cascade connection of two second control units 40 in two adjacent shift register units 11, and the output subunit 341 in the second control unit 40 is configured to provide a control signal to the output unit 20. For example, in the first working mode of the shift register unit 11, the stage transmission subunit 343 in the second control unit 40 outputs a valid pulse, and the output subunit 341 also outputs a valid pulse; in the second working mode, the stage transmission subunit 343 in the second control unit 40 outputs a valid pulse, and the output subunit 341 outputs a constant voltage signal

The display panel included in the embodiments of the present disclosure can realize that the i-th level shift register unit 11_i is in the first working mode and the (i+1)-th level shift register unit 11_i+1 is in the second working mode, and can also realize that the i-th level shift register unit 11_i is in the second working mode and the (i+1)-th level shift register unit 11_i+1 is in the first working mode. When applying the multi-area multi-frequency display, the magnitude relationship of the refresh rates in different display areas may not be restricted by the scanning direction. In a conventional display panel, a shift register unit is connected to a scanning line, and the display area is scanned row-by-row from top to bottom to realize the display. A display panel included in the embodiments of the present disclosure can realize that the refresh rates of the three areas from top to bottom of the display area are high refresh rate, low refresh rate, and then high refresh rate.

As shown in FIG. 24, two outputs of the input subunit 342 are respectively connected to the fourth node N4 and the fifth node N5. The stage transmission subunit 343 includes an eleventh transistor T11 and a twelfth transistor T12. The gate of the eleventh transistor T11 is connected to the fifth node N5, the first electrode receives the first level signal VGH, and the second electrode is connected to the output of the stage transmission subunit 343 (the output of the stage transmission subunit 343 in the first control unit 30 is Next1′, and the output of the stage transmission subunit 343 in the second control unit 40 is Next2′). The gate of the twelfth transistor T12 is connected to the fourth node N4, the first electrode receives the second clock signal XCK, and the second electrode is connected to the output of the stage transmission subunit 343.

As shown in FIG. 24, the input subunit 342 of the first control unit 30 and the second control unit 40 in the i-th level shift register unit 11_i is connected to the first clock signal CK, and the stage transmission subunit 343 is connected to the second clock signal XCK. The input subunit 342 of the first control unit 30 and the second control unit 40 in the j-th level shift register unit 11_j is connected to the second clock signal XCK, and the stage transmission subunit 343 is connected to the first clock signal CK. The first clock signal CK and the second clock signal XCK are a pair of clock signals. When describing the structure of the first control unit 30 and the second control unit 40 in the shift register unit 11, the first electrode of the eighth transistor T8 receives the first clock signal CK, or it can be understood that the first electrode of the eighth transistor T8 receives the second clock signal XCK; the first electrode of the twelfth transistor T12 receives the second clock signal XCK, or it can be understood that the first electrode of the twelfth transistor T12 receives the first clock signal CK. When the shift register is working, there is a certain time difference between the first clock signal CK and the second clock signal XCK only in the high level and low level timing.

FIG. 24 also schematically illustrates that the first control unit 30 and the second control unit 40 respectively include three stabilizing capacitors (not shown), where the stabilizing capacitors are configured to stabilize the node potential.

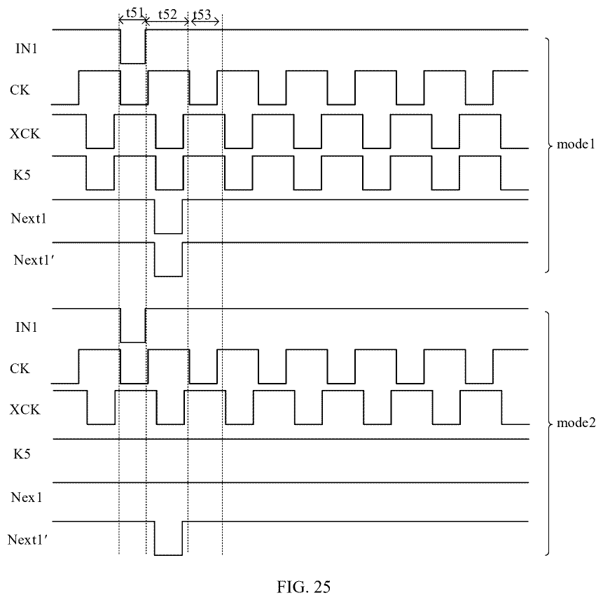

FIG. 25 is a working timing diagram of a first control unit in accordance with an embodiment of the present disclosure. FIG. 25 illustrates the signal timing of the first control unit 30 in the first working mode and the second working mode.

As shown in FIG. 25, in the first working mode 1 of the shift register unit 11: in the period t51, the low level of the first clock signal CK controls the sixth transistor T6 and the seventh transistor T7 to turn on, the fourth node N4 is written with a low level, the fifth node N5 is written with a low level, and the output Next1′ of the stage transmission subunit 343 and the output Next1 of the output subunit 341 both output a high level. In the period t52, the first clock signal CK is a high level, the fifth control signal K5 and the second clock signal XCK are both low levels, the eighth transistor T8 maintains an “on” state to write the high level of the first clock signal CK to the fifth node N5, and the fourth node N4 maintains a low level. At this time, the output Next1′ of the stage transmission subunit 343 and the output Next1 of the output subunit 341 both output a low level. In the period t53, the output Next1′ of the stage transmission subunit 343 and the output Next1 of the output subunit 341 both output a high level. The stage transmission subunit 343 transmits the valid pulse to the first control unit 30 of the next level shift register unit 11, and the output subunit 341 provides the valid pulse to the output unit 20.

In the second working mode 2 of the shift register unit 11: the fifth control signal K5 is a constant voltage signal; in the period t51, the output Next1′ of the stage transmission subunit 343 and the output Next1 of the output subunit 341 both output a high level; in the period t52, the first clock signal CK is a high level, the fifth control signal K5 is a high level, and the second clock signal XCK is a low level. In this period, the output Next1′ of the stage transmission subunit 343 outputs a low level, and the output Next1 of the output subunit 341 outputs a high level. In the period t53, the output Next1′ of the stage transmission subunit 343 and the output Next1 of the output subunit 341 both output a high level. The stage transmission subunit 343 transmits the valid pulse to the first control unit 30 of the next level shift register unit 11, and the output subunit 341 provides the high level constant voltage signal to the output unit 20.

The structure of the second control unit 40 is the same as that of the first control unit 30, and the two control units have similar working processes in the first working mode 1/the second working mode 2. The working of the second control unit 40 can be understood with reference to the illustrated embodiment in FIG. 25, and will not be described in detail here.

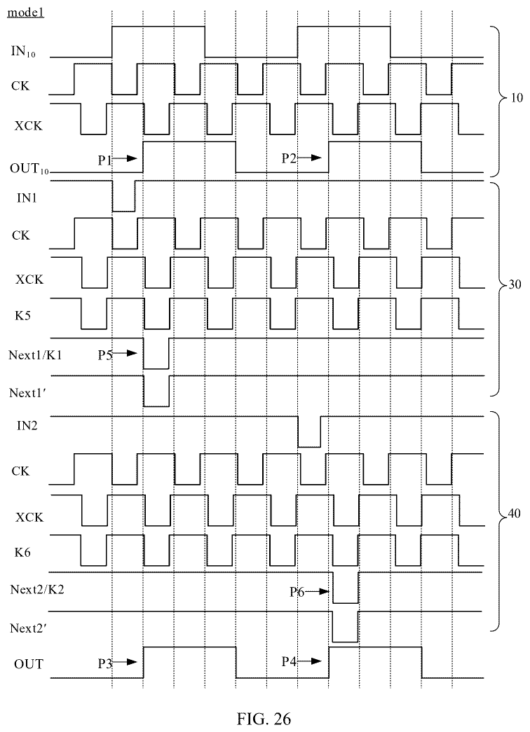

FIG. 26 is another timing diagram in accordance with an embodiment of the present disclosure. FIG. 26 illustrates a signal timing diagram that can realize the shift register unit 11 shown in FIG. 24 to select and output the second output signal, that is, the shift register unit 11 is in the first working mode 1. The working process of the shift register unit 11 in the illustrated embodiment in FIG. 24 is understood in conjunction with FIG. 18 and FIG. 26. FIG. 26 illustrates the signal timing of the driving unit 10, the first control unit 30, the second control unit 40, and the output OUT of the output unit 20.

As shown in FIG. 26, the output OUT10 of the driving unit 10 provides a first output signal, and the n valid pulses of the first output signal include a first valid pulse P1 and a second valid pulse P2. The output OUT1 of the output unit 20 outputs a second output signal, and the n valid pulses of the second output signal include a third valid pulse P3 and a fourth valid pulse P4. In the first working mode 1, the first control signal K1 provided by the output Next1 of the output subunit 341 in the first control unit 30 includes a fifth valid pulse P5, and the second control signal K2 provided by the output Next2 of the output subunit 341 in the second control unit 40 includes a sixth valid pulse P6. The output unit 20 outputs the third valid pulse P3 when receiving at least the first valid pulse P1 and the fifth valid pulse P5, and outputs the fourth valid pulse P4 when receiving at least the second valid pulse P2 and the sixth valid pulse P6, so as to allow the shift register unit 11 to select and output a signal including two valid pulses. Here, the valid pulses of the first output signal and the second output signal are high level valid pulses, and the valid pulses of the first control signal K1 and the second control signal K2 are low level valid pulses. Additionally, in the first working mode 1, the output Next1′ of the stage transmission subunit 343 of the first control unit 30 outputs a valid pulse and provides the valid pulse to the input IN1 of the first control unit 30 in the next-level shift register unit 11, and the output Next2′ of the stage transmission subunit 343 of the second control unit 40 also outputs a valid pulse and provides the valid pulse to the input IN2 of the second control unit 40 in the next-level shift register unit 11.

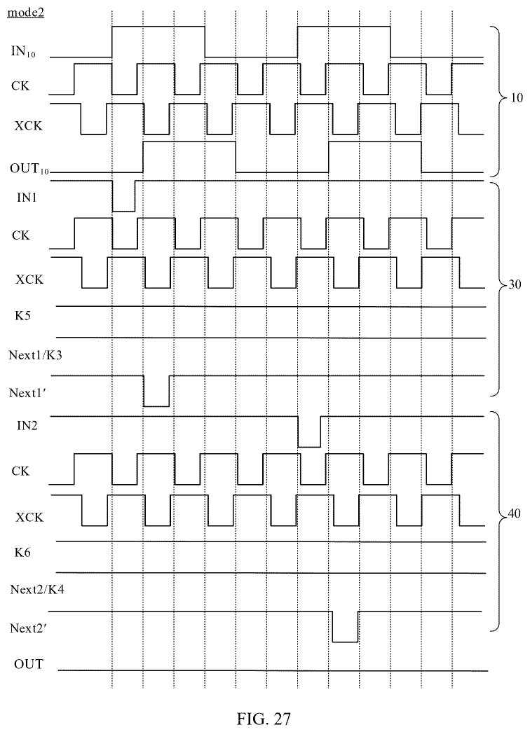

FIG. 27 is another timing diagram in accordance with an embodiment of the present disclosure. FIG. 27 illustrates a signal timing that can realize the shift register unit 11 shown in FIG. 24 to select and output a low level constant voltage signal, that is, the shift register unit is in the second working mode 2. The working process of the shift register unit 11 in the illustrated embodiment in FIG. 24 is understood in conjunction with FIG. 19 and FIG. 27. FIG. 27 illustrates the signal timing of the driving unit 10, the first control unit 30, the second control unit 40, and the output OUT of the output unit 20.

As shown in FIG. 27, in the second working mode 2: the fifth control signal K5 received by the first control unit 30 and the sixth control signal K6 received by the second control unit 40 are both first level signals VGH. The output Next1 of the output subunit 341 of the first control unit 30 outputs a high level as the third control signal K3; the output Next2 of the output subunit 341 of the second control unit 40 outputs a high level as the fourth control signal K4. Further, when the output unit 20 receives the first output signal, the third control signal K3 output by the first control unit 30 and the fourth control signal K4 output by the second control unit 40, the output OUT of the output unit 20 outputs a low level constant voltage signal, so that the shift register unit 11 is selected to output the constant voltage signal. Additionally, in the second working mode 2, the output Next1′ of the stage transmission subunit 343 of the first control unit 30 outputs a valid pulse and provides the valid pulse to the input IN1 of the first control unit 30 in the next-level shift register unit 11, and the output Next2′ of the stage transmission subunit 343 of the second control unit 40 also outputs a valid pulse and provides the valid pulse to the input IN2 of the second control unit 40 in the next-level shift register unit 11.

Corresponding to the above embodiments, as shown in FIG. 9, a display panel includes a first display frame, in which: the 1st to p-th level shift register units 11 are in the first working mode 1, the (p+1)-th to q-th level shift register units 11 are in the second working mode 2, and the (q+1)-th to m-th level shift register units 11 are in the first working mode 1, where m, q, and p are all positive integers, and 1<p<q<m≤N. In the first working mode 1 of the shift register unit 11, the output unit 20 is configured to at least receive the first output signal, the first control signal K1 output by the first control unit 30, and the second control signal K2 output by the second control unit 40, and output the second output signal including at least two valid pulses; in the second working mode 2 of the shift register unit 11, the output unit 20 is configured to at least receive the first output signal, the third control signal K3 output by the first control unit 30, and the fourth control signal K4 output by the second control unit 40, and output a constant voltage signal. Since the shift register unit 11 is provided with a stage transmission subunit 343, the magnitude relationship of the refresh rates in different display areas is not limited by the scanning direction. The display panel included in the embodiments of the present disclosure can realize the high refresh rate, low refresh rate, and high refresh rate multi-area multi-frequency display of the first display area Q1, the second display area Q2, and the third display area Q3 shown in FIG. 9 from top to bottom.

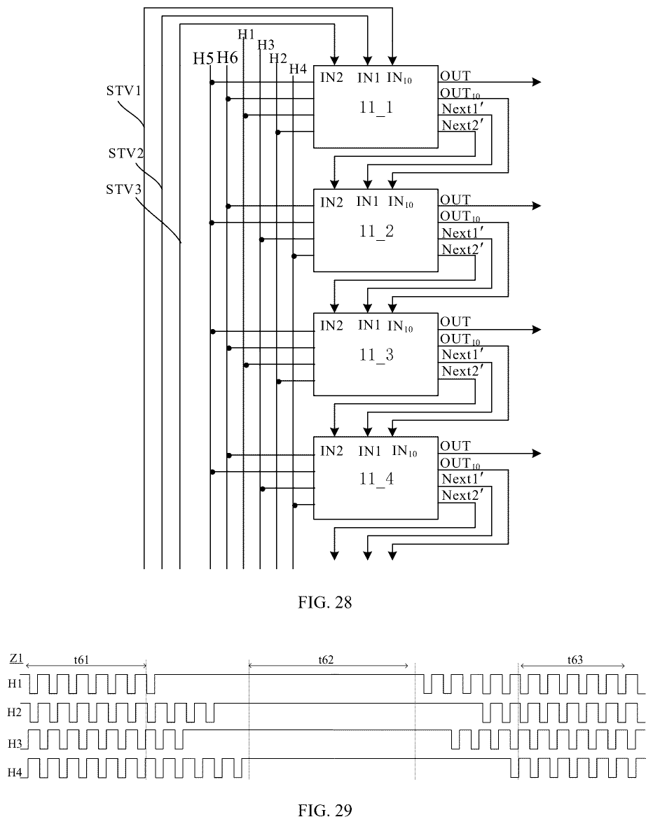

FIG. 28 is a schematic diagram of another circuit in a display panel in accordance with an embodiment of the present disclosure. As shown in FIG. 28, the display panel includes a first signal line H1, a second signal line H2, a third signal line H3, and a fourth signal line H4. The first signal line H1 and the third signal line H3 provide a fifth control signal K5, and the second signal line H2 and the fourth signal line H4 provide a sixth control signal K6 In the first working mode 1, the fifth control signal K5 and the sixth control signal K6 are periodic pulse signals. In the second working mode 2, the fifth control signal K5 and the sixth control signal K6 are constant voltage signals.

FIG. 28 illustrates the 1st level shift register unit 11_1 to the fourth level shift register unit 11_4 in the first shift register. In conjunction with the cascade relationship in the illustrated embodiment in FIG. 24, the output subunit 341 of the first control unit 30 in the 1st level shift register unit 11_1 and the third level shift register unit 11_3 is connected to the first signal line H1, and the output subunit 341 of the second control unit 40 is connected to the second signal line H2. The output subunit 341 of the first control unit 30 in the second level shift register unit 11_2 and the fourth level shift register unit 11_4 is connected to the third signal line H3, and the output subunit 341 of the second control unit 40 is connected to the fourth signal line H4. Additionally, the output Next1′ of the stage transmission subunit 343 of the first control unit 30 is connected to the input IN1 of the first control unit 30 in the next level shift register unit 11, and the output Next2′ of the stage transmission subunit 343 of the second control unit 40 is connected to the input IN2 of the second control unit 40 in the next level shift register unit 11.

FIG. 29 illustrates other signal timing diagrams in accordance with an embodiment of the present disclosure. FIG. 29 illustrates the signal timings on the first signal line H1 to the fourth signal line H4 when driving the display panel to display the first display frame. As shown in FIG. 29, the first display frame Z1 includes a fourth period t61, a fifth period t62, and a sixth period t63.

In the fourth period t61, the first signal line H1, the second signal line H2, the third signal line H3 and the fourth signal line H4 provide periodic pulse signals respectively, the first signal line H1 and the second signal line H2 provide the same signal, and the third signal line H3 and the fourth signal line H4 provide the same signal.

In the fifth period t62, the first signal line H1 and the second signal line H2 provide constant voltage signals respectively, and the third signal line H3 and the fourth signal line H4 provide constant voltage signals respectively.

In the sixth period t63, the first signal line H1, the second signal line H2, the third signal line H3, and the fourth signal line H4 respectively provide periodic pulse signals.

Adopting the signal timing illustrated in FIG. 29, the shift register unit 11 driven by the four signal lines can be in the first working mode in the fourth period t61, the shift register unit 11 driven by the four signal lines can be in the second working mode in the fifth period t62, and the shift register unit 11 driven by the four signal lines can be in the first working mode in the sixth period t63, so that different data refresh conditions of different display areas of the same display panel in the first display frame Z1 can be achieved. For example, the shift register units 11 from the 1st to the p-th level are in the first working mode, and the corresponding display areas perform image data refresh, the shift register units 11 from the (p+1)-th to the q-th level are in the second working mode, and the corresponding display areas do not perform image data refresh, and the shift register units 11 from the (q+1)-th to the m-th level are in the first working mode, and the corresponding display areas perform image data refresh. In the fifth period t62, the four signal lines provide constant voltage signals respectively, which can help reduce power consumption.

In some embodiments, in the fifth period t62: the first signal line H1 and the second signal line H2 provide constant voltage signals respectively, and the third signal line H3 and the fourth signal line H4 still provide periodic pulse signals; or, the first signal line H1 and the second signal line H2 still provide periodic pulse signals, and the third signal line H3 and the fourth signal line H4 provide constant voltage signals respectively. That is, in the first display frame Z1, only the signals provided by some signal lines are changed into constant voltage signals, which can also play a role in reducing power consumption.

Additionally, as shown in FIG. 29, there are signal leaps on at least some of the signal lines in the period between the fourth period t61 and the fifth period t62. The “signal leap” refers to the periodic pulse signal becoming a constant voltage signal. The moment of the signal leap refers to the moment when the periodic pulse signal switches to the constant voltage signal. Specifically, the moment of the signal leap on the first signal line H1 is earlier than the moment of the signal leap on the second signal line H2, the moment of the signal leap on the third signal line H3 is earlier than the moment of the signal leap on the fourth signal line H4, and the moment of the signal leap on the first signal line H1 is earlier than the moment of the signal leap on the third signal line H3. Additionally, there are signal leaps on at least some of the signal lines in the period between the fifth period t62 and the sixth period t63. This period is a “signal leap”, which means that the signal changes from a constant voltage signal to a periodic pulse signal, and the moment of the signal leap refers to the moment when the constant voltage signal switches to a periodic pulse signal. Specifically, the signal leap time on the first signal line H1 is earlier than the signal leap time on the second signal line H2, the signal leap time on the third signal line H3 is earlier than the signal leap time on the fourth signal line H4, and the signal leap time on the first signal line H1 is earlier than the signal leap time on the third signal line H3. Such a configuration can ensure that the shift register unit 11 connecting the first signal line H1 and the second signal line H2 normally outputs n valid pulses in the first working mode to avoid the loss of pulse signals. It can also ensure that the shift register unit 11 connecting the third signal line H3 and the fourth signal line H4 normally outputs n valid pulses in the first working mode to avoid the loss of pulse signals. The embodiments of the present disclosure can ensure that display abnormality will not occur near the boundary of the area and frequency display in the first display frame Z1.

It should be noted that in the second display frame, the first signal line H1, the second signal line H2, the third signal line H3, and the fourth signal line H4 respectively provide periodic pulse signals, so that each shift register unit 11 is in the first working mode. The first display frame and the second display frame cooperate, such as executing at least one first display frame between two adjacent second display frames, so that the display panel can be displayed in a multi-area multi-frequency manner, thereby reducing the power consumption of the display panel.

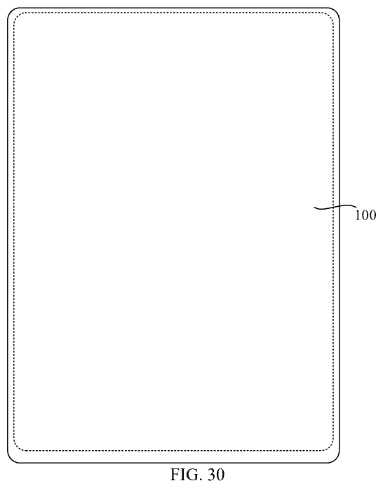

Based on the same inventive concept, embodiments of the present disclosure further include a display device. FIG. 30 is a schematic diagram of a display device in accordance with an embodiment of the present disclosure. As shown in FIG. 30, the display device includes a display panel 100 in accordance with an embodiment of the present disclosure. The structure of the display panel 100 has been described in the above embodiments and will not be repeated here. The display device included in the embodiments of the present disclosure can be, for example, an electronic device with a display function, such as a mobile phone, a tablet computer, a laptop computer, a television, etc.

The display panel and display device included in the embodiments of the present disclosure have the following beneficial effects: a shift register unit is provided, including a driving unit, an output unit, a first control unit, and a second control unit, and the driving unit has a signal shifting function. In the first working mode of the shift register unit, when the driving unit outputs n valid pulses, the output unit can output n valid pulses under the joint control of the driving unit, the first control unit, and the second control unit. When applying the multi-area multi-frequency display technology, the shift register unit can meet the requirements of the pixel circuit in the high-frequency refresh area for multi-pulse signals, and avoid the problem of poor display effects caused by the lack of valid pulses.

The above description are merely some embodiments of the present disclosure and is not intended to limit the present disclosure. Any modifications, equivalent substitutions, improvements, etc., made within the spirit and principles of the present disclosure should be included in the scope of protection of the present disclosure.

Furthermore, it should be noted that the above embodiments are merely used to illustrate the technical solutions of the present disclosure, rather than to limit it. Although the present disclosure has been described in detail with reference to the specific embodiments, those skilled in the art should understand that they can still modify the technical solutions described in these embodiments, or replace some or all of the technical features therein by equivalents. However, these modifications or replacements do not make the essence of the corresponding technical solutions deviate from the scope of the technical solutions of the embodiments of the present disclosure.

What is claimed is:

1. A display panel, comprising: N cascaded shift register units, wherein a shift register unit includes a driving unit, an output unit, a first control unit, and a second control unit, and N is a positive integer, and wherein:
an output of the driving unit outputs a first output signal, and a first output signal output by a driving unit of an i-th level shift register unit is an input signal of a driving unit of a j-th level shift register unit, wherein 1≤i≤N, 1≤j≤N, i and j are both positive integers, and i≠j;
the output unit is connected to an output of the driving unit, an output of the first control unit, and an output of the second control unit respectively; and
the first output signal includes n valid pulses, in a first working mode of the shift register unit, the output unit is configured to at least receive the first output signal, a first control signal output by the first control unit, and a second control signal output by the second control unit, and output a second output signal, wherein the second output signal includes n valid pulses, n is a positive integer, and n≥2.

2. The display panel according to claim 1, wherein:
in a second working mode of the shift register unit, the output unit is configured to at least receive the first output signal, a third control signal output by the first control unit and a fourth control signal output by the second control unit, and output a constant voltage signal, wherein the third control signal and the fourth control signal are constant voltage signals.

3. The display panel according to claim 2, wherein:
the display panel includes a first display frame; and
in the first display frame, the shift register units from a 1st level to a p-th level are in the first working mode, and the shift register units from a (p+1)-th level to a q-th level are in the second working mode, wherein p and q are positive integers, and 1<p<q≤N.

4. The display panel according to claim 3, wherein:
in the first display frame, shift register units from a (q+1)-th level to a m-th level are in the first working mode, m is a positive integer, and q<m≤N.

5. The display panel according to claim 3, wherein:
the display panel includes a second display frame; and
in the second display frame, the N shift register units are all in the first working mode.

6. The display panel according to claim 1, wherein:
the output unit includes a first submodule, a second submodule and an output submodule, a control end of the first submodule is connected to the output of the driving unit, two control ends of the second submodule that are connected to the output of the first control unit and the output of the second control unit, and an output of the first submodule, an output of the second submodule, and at least one control end of the output submodule are connected to a first node,
wherein, in the first working mode:
the first submodule is configured to be turned on during an invalid pulse period of the first output signal, and turned off during a valid pulse period of the first output signal;
the second submodule is configured to be turned on during a valid pulse period of the first control signal or during a valid pulse period of the second control signal, and to be turned off during a period when both the first control signal and the second control signal are invalid pulses; and
the output submodule is configured to output a first level signal when a signal corresponding to the first node is in a second level period under the control of the first submodule and the second submodule, and to output a second level signal when a signal corresponding to the first node is in a first level period, and the first level signal and the second level signal form the second output signal.

7. The display panel according to claim 6, wherein:
in a second working mode of the shift register unit, the output unit is configured to receive at least a first output signal, a third control signal output by the first control unit and a fourth control signal output by the second control unit, and output a constant voltage signal,
wherein, in the second working mode:
the first submodule is configured to be turned on during an invalid pulse period of the first output signal, and turned off during a valid pulse period of the first output signal;
the second submodule is configured to be turned off under the control of the third control signal and the fourth control signal; and
the output submodule is configured to output a constant voltage signal under the control of its control end.

8. The display panel according to claim 6, wherein:
an input of the first submodule and a first input of the output submodule receive a first level signal, and an input of the second submodule and a second input of the output submodule receive a second level signal,
wherein in the first working mode:
the first submodule is configured to be turned on during an invalid pulse period of the first output signal and write the first level signal into the first node;
the second submodule is configured to be turned on during a valid pulse period of the first control signal or during a valid pulse period of the second control signal, and write the second level signal into the first node; and
the output submodule is configured to output the second level signal during a period when the first node is the first level signal, and to output the first level signal during a period when the first node is the second level signal.

9. The display panel according to claim 8, wherein:
the output submodule includes a first control end and a second control end, and the first control end is connected to the first node;
the driving unit includes a second node, a third node and a driving output module, two control ends of the driving output module are connected to the second node and the third node respectively, and an output of the driving output module is connected to the output of the driving unit;
the driving output module is configured to output the second level signal under the control of a potential of the second node, and to output the first level signal under the control of a potential of the third node, wherein the first level signal and the second level signal form the first output signal; and
the second control end is connected to the third node or the second node.

10. The display panel according to claim 9, wherein:
the output submodule includes a first transistor and a second transistor;
a gate of the first transistor is connected to the first node, a first electrode of the first transistor receives the first level signal, and a second electrode of the first transistor is connected to an output of the output submodule, a gate of the second transistor is connected to the second node, a first electrode of the second transistor receives the second level signal, and a second electrode of the second transistor is connected to the output of the output submodule; and
the first transistor and the second transistor are both N-type transistors or both P-type transistors.

11. The display panel according to claim 9, wherein:
the output submodule includes a first transistor and a second transistor;
a gate of the first transistor is connected to the first node, a first electrode of the first transistor receives the first level signal, and a second electrode of the first transistor is connected to an output of the output submodule, a gate of the second transistor is connected to the third node, a first electrode of the second transistor receives the second level signal, and a second electrode of the second transistor is connected to the output of the output submodule; and
one of the first transistor and the second transistor is an N-type transistor, and the other is a P-type transistor.

12. The display panel according to claim 8, wherein:
a second control end of the output submodule is connected to the first node;
the output submodule includes a first transistor and a second transistor;
a gate of the first transistor is connected to the first node, a first electrode of the first transistor receives the first level signal, and a second electrode of the first transistor is connected to an output of the output submodule, a gate of the second transistor is connected to the first node, a first electrode of the second transistor receives the second level signal, and a second electrode of the second transistor is connected to the output of the output submodule; and
one of the first transistor and the second transistor is an N-type transistor, and the other is a P-type transistor.

13. The display panel according to claim 8, wherein:
the first submodule includes a third transistor, a gate of the third transistor is connected to the output of the driving unit, a first electrode of the third transistor receives the first level signal, and a second electrode of the third transistor is connected to the first node.

14. The display panel according to claim 8, wherein:
the second submodule includes a fourth transistor and a fifth transistor; and
a gate of the fourth transistor is connected to the output of the first control unit, a first electrode of the fourth transistor receives the second level signal, and a second electrode of the fourth transistor is connected to the first node, a gate of the fifth transistor is connected to the output of the second control unit, a first electrode of the fifth transistor receives the second level signal, and a second electrode of the fifth transistor is connected to the first node.

15. The display panel according to claim 1, wherein:
the n valid pulses of the first output signal include a first valid pulse and a second valid pulse, and the n valid pulses of the second output signal include a third valid pulse and a fourth valid pulse; and
the first control signal includes a fifth valid pulse, and the second control signal includes a sixth valid pulse,
wherein in the first working mode:
the output unit is configured to output the third valid pulse when at least the first valid pulse and the fifth valid pulse are received, and to output the fourth valid pulse when at least the second valid pulse and the sixth valid pulse are received.

16. The display panel according to claim 15, wherein:
in the first working mode, a start time of the fifth valid pulse is not earlier than a start time of the first valid pulse, and a start time of the sixth valid pulse is not earlier than a start time of the second valid pulse.

17. The display panel according to claim 16, wherein:
in the first working mode, a start time of the third valid pulse is not earlier than the start time of the fifth valid pulse, an ending time of the third valid pulse is not later than an ending time of the first valid pulse, a start time of the fourth valid pulse is not earlier than the start time of the sixth valid pulse, and an ending time of the fourth valid pulse is not later than an ending time of the second valid pulse.

18. The display panel according to claim 16, wherein:
the first control unit and the second control unit both include an output subunit; and
an input of an output subunit of the first control unit receives the first level signal, and another input of the output subunit of the first control unit receives a fifth control signal, an input of an output subunit of the second control unit receives the first level signal, and another input of the output subunit of the second control unit receives a sixth control signal,
wherein, in the first working mode:
the output subunit of the first control unit is configured to output the fifth valid pulse according to the first level signal and the fifth control signal, and the output subunit of the second control unit is configured to output the sixth valid pulse according to the first level signal and the sixth control signal.

19. The display panel according to claim 18, wherein:
in the second working mode of the shift register unit, the output unit is configured to receive at least the first output signal, a third control signal output by the first control unit and a fourth control signal output by the second control unit, and output a constant voltage signal,
wherein, in the second working mode:
the fifth control signal and the sixth control signal are both first level signals; and
the output subunit of the first control unit is configured to output the first level signal as the third control signal, and the output subunit of the second control unit is configured to output the first level signal as the fourth control signal.

20. A display device, including a display panel, and the display panel comprising: N cascaded shift register units, wherein a shift register unit includes a driving unit, an output unit, a first control unit, and a second control unit, and N is a positive integer, and wherein:
an output of the driving unit outputs a first output signal, and a first output signal output by a driving unit of an i-th level shift register unit is an input signal of a driving unit of a j-th level shift register unit, wherein 1≤i≤N, 1≤j≤N, i and j are both positive integers, and i≠j;
the output unit is connected to an output of the driving unit, an output of the first control unit, and an output of the second control unit respectively; and
the first output signal includes n valid pulses, in a first working mode of the shift register unit, the output unit is configured to at least receive the first output signal, a first control signal output by the first control unit, and a second control signal output by the second control unit, and output a second output signal, wherein the second output signal includes n valid pulses, n is a positive integer, and n≥2.
